(19) United States
(12) Patent Application Publication
(10) Pub. No.: US 2020/0000087 A1
(43) Pub. Date: Jan. 2, 2020

(54) COMPOSITIONS FOR APPLICATION TO AERIAL PARTS OF PLANTS

(71) Applicant: EXOSECT LIMITED, Winchester Hampshire (GB)

(72) Inventors: Kristi THOMAS, Winchester Hampshire (GB); Aoife DILLON, Winchester Hampshire (GB); Igor CURCIC, Winchester Hampshire (GB); Fiona MOONEY, Winchester Hampshire (GB)

(21) Appl. No.: 16/486,070

(22) PCT Filed: Feb. 13, 2018
(86) PCT No.: PCT/EP2018/053536

§ 371 Date: Aug. 14, 2019

(30) Foreign Application Priority Data
Feb. 14, 2017 (GB) 1702388.8

(51) Int. Cl. A01N 25/04; A01N 43/60; A01N 37/18; A01N 43/54

(52) U.S. Cl. CPC A01N 25/04; A01N 43/54; A01N 37/18; A01N 43/60

(57) ABSTRACT

Treatment of plants using systemic herbicides and pesticides is achieved using a liquid formulation for applying to aerial parts of the plants, the formulation comprising i) a non-arthropod systemically-acting pesticide; and ii) carrier particles including at least an outer surface comprising an organic matter constituent, wherein the said systemically-acting pesticide is combined within and/or on the surface of the carrier particles, the carrier particles being in particulate form and capable of carrying an electrostatic surface charge.

### INTRODUCTION

The present invention relates to particles carrying non-arthropod pesticides for coating aerial parts of plants, methods of coating aerial parts of plants with active agents selected from non-arthropod pesticides such as herbicides and fungicides, and uses of particles comprising non-arthropod pesticides in coating aerial parts of plants. In particular, the invention relates to aqueous compositions comprising electrostatically charged particles bearing non-arthropod pesticides selected from herbicides and fungicides capable of crossing plant cuticles, and their manufacture, aerial plant parts comprising such particles, methods of coating aerial plant parts with electrostatically charged particles carrying non-arthropod pesticides capable of crossing the plant cuticle and acting systemically within the plant, and uses of electrostatic particles comprising such systemic pesticides.

### BACKGROUND TO THE INVENTION

Infestation by weeds on land where crops of use to man are grown, such as on arable land, if not controlled can be a major cause of economic loss. Many means of treating weed infestation in crops through the application of herbicides are practised worldwide. It is a constant battle to keep one step ahead of weed evolution and/or to maintain or improve weed controlling activities.

A problem associated with the conventional use of chemical herbicides provided in liquid form for controlling weeds where the chemistry needs to be taken up through the plant foliage is that the weeds do not all germinate at the same time. Weeds not present in the crop during the initial spraying escape the treatment and then germinate and grow. As a result, the user has to repeatedly apply herbicides in order to maintain control over weed infestation. This in turn means that the environs to which the herbicides are applied will receive high chemical loads and this may have an adverse effect. A further issue with the application of such chemical agents to plant surfaces in liquid form is that the application of them is regulated in certain countries in order to protect the environment and so the farmer is constrained by how much herbicide he may use per year and/or in any one crop type per growing season. The application of liquid forms of herbicide tends to be patchy at best, and so target organisms (weeds) may substantially evade the applied pesticide. When conventional pesticides are applied to aerial plant parts, in the form of sprays, mists, washes, baths and the like, losses to the environment tend to be high because active agents may also be washed off through the action of rain or of irrigation equipment, and a high proportion of the active chemical may be lost to the environment. Such environmental action tends to limit the effectiveness of pesticides applied in liquid form and may in itself lead to chemical loads to the environment which may be damaging to domesticated and wild animals, amphibians, wild birds and the like.

Similar problems are associated with the conventional use of chemical fungicides provided in liquid form. While the fungicides provided may be effective for short periods of time after application, over longer periods of time, conventional chemical fungicides may be less effective. As a result, the user has to apply relatively high concentrations of fungicides more frequently in order to maintain control over fungal infestation. However, it may also be the case that once fungal infestation is detected in a crop, it may already be too late to apply chemical fungicide to prevent destruction of a significant percentage of the crop or even an entire crop. As for herbicides, the application of such chemical agents to plant surfaces in liquid form is regulated in certain countries in order to protect the environment and so the farmer may be constrained as to how much fungicide he may use per year and/or in any one crop type over a growing season.

GB 2481881 relates to a liquid composition comprising electret particles carrying pesticides against arthropods that are sprayed onto crop plants using conventional spraying equipment. The liquid compositions of GB 2481881 further comprise a surfactant that prevents the particles from clogging up the nozzles of the spraying equipment. There is no mention of making particles comprising systemically-acting herbicides and/or systemically-acting fungicides or of using novel formulation methods to acquire such electrostatic particles in aqueous formulations.

The ability to add electrostatic particles comprising systemically-acting herbicides and/or systemically-acting fungicides in aqueous formulations that are presented to aerial plant parts is considered desirable since it would maximize the effectiveness of the treatment to the aerial parts of plants and in the case of herbicides obviates problems associated with the conventional application of herbicides as alluded to above. An additional advantage of using electrostatic particles as carriers of systemically-acting herbicides is that fewer unintentional side effects may be realised in the environment.

In the case of using electrostatic particles as carriers of systemically-acting fungicides, a single application may be enough to prevent an outbreak of fungal disease in a crop over a plant growth cycle. The advantages that pertain to using systemically-acting herbicide formulations as alluded to above, broadly speaking also apply to the application of systemically-acting fungicide formulations of the invention.

It has now been found that electrostatic particles comprising systemic non-arthropod pesticides can be provided to aerial plant parts. Such electrostatic particles are capable of adhering to the surfaces of aerial plant parts such as leaves, stems, and flowers, and release in the case of systemically-acting fungicides that are taken up by the aerial plant parts in sufficient quantities that kill or disable fungi which infest crop plants. Plants treated with electrostatic particles comprising systemic fungicides of the invention show little or no loss of viability.

Hitherto, it was expected that the formulation of pesticide in wax would inhibit the uptake/activity of systemically-acting pesticides (whether the activity was herbicidal or fungicidal), given the fact that plant waxes in the plant cuticle have a protective function, acting as a barrier to the uptake of pesticides. The inventors have made the surprising finding that systemically-acting pesticides formulated in electrostatic wax particles are as biologically active as conventional chemical formulations, which have a shorter diffusion pathway.

By bringing pesticides of use in the invention into contact with the plant cuticle wall by making use of the electrostatic properties of particles of the invention, quantities of systemically-acting pesticide can be transferred into the plant. Where the quantity of pesticide transferred into the plant is a systemically-acting fungicide, a sufficient amount of it is retained therein and as a consequence the viability of fungal pests which attack the plant is substantially reduced. Where the quantity of pesticide transferred into the non-crop plant (i.e. a weed) is a systemically-acting herbicide, a sufficient amount of it is retained therein and as a consequence it is killed or its viability is substantially reduced.

There exists a need to overcome or at least reduce the drawbacks of conventional methods of treating pest infestations in the field. This and other advantages will become apparent from the following description and examples.

### SUMMARY OF THE INVENTION

According to the present invention there is provided a liquid formulation for applying to aerial parts of plants comprising:
i) a non-arthropod systemically-acting pesticide; and
ii) carrier particles including at least an outer surface comprising an organic matter constituent,
   wherein the said systemically-acting pesticide is combined within and/or on the surface of the carrier particles, the carrier particles being in particulate form and capable of carrying an electrostatic surface charge.

Also provided according to the invention is a method of delivering a non-arthropod systemically-acting pesticide to a plant, comprising applying to one or more aerial parts of the plant (i) a liquid formulation of the invention, or (ii) particles according to the invention.

Method of the invention may be for killing the plant, wherein the pesticide is a herbicide.

Methods of the invention may be for treating or preventing fungal infection of the plant, wherein the pesticide is a fungicide.

### DETAILS OF THE INVENTION

The aerial parts of plants to which formulations of the invention are applied are typically the leaves, stems, petioles, and flower parts of the target plant population.

The carrier particles of use in the invention may be made of any material comprising natural waxes, synthetic waxes, and/or mineral waxes having a melting point of ≥40° C., polymers such as polyethylene, polypropylene, oxidised polyethylenes and polypropylenes etc. The particles may be solid wax particles and made substantially throughout of wax or wax mixtures (allowing for the carried pesticide and optional components at low levels). Typically, waxes of use as systemic pesticide carriers in the invention have a melting temperature of ≥40° C., depending on design. Preferably, waxes of use in the invention include waxes having a melting point of preferably ≥50° C., and most preferably are made up of so-called hard waxes having a melting point of ≥70° C.

Synthetic waxes of use in the present invention include suitable waxes selected from paraffin wax, microcrystalline wax, Polyethylene waxes, Fischer-Tropsch waxes, substituted amide waxes, polymerized α-olefins and the like.

Mineral waxes of use in the invention include montan wax (e.g. Luwax® BASF) ceresin wax, ozocerite, peat wax and the like.

Suitable natural waxes of use in the invention as carriers of systemic pesticides include those selected from paraffin wax, beeswax, carnauba wax, lanolin, shellac wax, bayberry wax, sugar cane wax, ozocerite, ceresin wax, montan wax, candelilla wax, castor wax, wool wax, microcrystalline wax, ouricury wax, Chinese wax, spermaceti wax, myricyl palmitate, cetyl palmitate, retamo wax and rice bran wax and mixtures of two or more thereof. In a preferment, the electrostatic particles of use in the invention comprise substantially wax or wax mixtures, more preferably comprise substantially carnauba wax or polyethylene wax and combinations thereof.

Preferably, the electrostatic carrier particles of use in the invention consist essentially of wax or wax mixtures or consist essentially of carnauba wax or polyethylene wax or combinations thereof.

The non-arthropod pesticide may be selected from a systemically-acting fungicide and a systemically-acting herbicide. Where the non-arthropod pesticide is a systemically-acting fungicide it may be selected from systemic benzimidazoles, systemic imidazoles, systemic Carboxin and related compounds (Oxathiins), systemic carbamates, systemic phenylamides, systemic phosphonates, systemic pyrimidines, systemic pyridines, systemic piperazines, systemic triazoles, systemic morpholines, systemic strobilurins, systemic phosphorothiolates, systemic cyanoacetamide oximes, systemic aryl sulfonylallyl trichloromethyl sulfoxides and mixtures of two or more thereof. Specific examples of the kinds of systemically-acting fungicides that may be employed in formulations of the invention include those such as systemically-acting strobilurins selected from Azoxystrobin, Dimoxystrobin, Enestrobin (also known as Enestroburin), Fluoxastrobin, Pyraclostrobin, Picoxystrobin, Kresoxim-methyl, Metominostrobin, and Trifloxystrobin and mixtures of two or more thereof. Further systemically-acting fungicides of use in the invention are those selected from the systemic benzimidazoles such as Benomyl (IUPAC name methyl 1-(butylcarbamoyl)benzimidazol-2-ylcarbamate), Thiophanate-methyl (IUPAC name dimethyl 4,4′-(o-phenylene)bis(3-thioallophanate), Thiabendazole (IUPAC name 2-(thiazol-4-yl)benzimidazole) and Carbendazim (IUPAC name methyl benzimidazol-2-ylcarbamate), Fuberidazole (IUPAC name 2-(2′-furyl)benzimidazole); the systemic Imidazoles such as Triflumizole (IUPAC name (E)-4-chloro-α,α,α-trifluoro-N-(1-imidazol-1-yl-2-propoxyethylidene)-o-toluidine), and Imazalil (IUPAC name (RS)-1-(β-allyloxy-2,4-dichlorophenylethyl) imidazole); the systemic carbamates such as Iprovalicarb (IUPAC name isopropyl 2-methyl-1-{[(RS)-1-p-tolylethyl]carbamoyl}-(S)-propylcarbamate), Propamocarb, (IUPAC name Propyl [3-(dimethylamino)propyl]carbamate), Methiocarb (IUPAC name 3,5-Dimethyl-4-(methylsulfanyl)phenyl N-methylcarbamate), BenDiocarb (IUPAC name (2,2-Dimethyl-1,3-benzodioxol-4-yl)N-methylcarbamate); the systemic phenylamides such as Carpropamid (IUPAC name a mixture of (1R,3S)-2,2-dichloro-N-[(R)-1-(4-chlorophenyl)ethyl]-1-ethyl-3-methylcyclopropanecarbox-amide, (1S,3R)-2,2-dichloro-N-[(R)-1-(4-chlorophenyl)ethyl]-1-ethyl-3-methylcyclopropanecarboxamide, (1S,3R)-2,2-dichloro-N-[(S)-1-(4-chlorophenyl)ethyl]-1-ethyl-3-methylcyclopropanecarboxamide and (1R,3S)-2,2-dichloro-N-[(S)-1-(4-chlorophenyl)ethyl]-1-ethyl-3-methylcyclopropanecarboxamide)); Metalaxyl (IUPAC name 2-[(2,6-dimethylphenyl)-(2-methoxy-1-oxoethyl) amino]propanoic acid methyl ester or methyl N-(methoxyacetyl)-N-(2,6-xylyl)-DL-alaninate); Metalaxyl-M (IUPAC name methyl N-(methoxyacetyl)-N-(2,6-xylyl)-D-alaninate); Benalaxyl (IUPAC name methyl N-(phenylacetyl)-N-(2,6-xylyl)-DL-alaninate); and Furalaxyl (IUPAC name methyl N-(2-furoyl)-N-(2,6-xylyl)-DL-alaninate); the systemic phosphonates such as Fosetyl-Al (IUPAC name aluminium tris(ethyl phosphonate)); the systemic pyrimidines such as Cyprodinil (an anilinopyrimidine—IUPAC name 4-cyclopropyl-6-methyl-N-phenylpyrimidin-2-amine); the systemic pyridines such as Pyrifenox (IUPAC name 2′,4′-dichloro-2-(3-pyridyl)acetophenone (EZ)-O-methyloxime), Fenarimol (IUPAC name (RS)-2,4′-dichloro-a-(pyrimidin-5-yl)benzhydryl alcohol); the systemic Piperidines such as Fenpropidin (IUPAC name 1-[(RS)-3-(4-tert-butylphenyl)-2-methylpropyl]piperidine); the systemic triazoles such as Flusilazole (IUPAC name bis(4-fluorophenyl)(methyl)(1H-1,2,4-triazol-1-ylmethyl)silane), Tebuconazole (IUPAC name (RS)-1-p-chlorophenyl-4,4-dimethyl-3-(1H-1,2,4-triazol-1-ylmethyl)pentan-3-ol), Cyproconazole (IUPAC name (2RS,3RS;2RS,3SR)-2-(4-chlorophenyl)-3-cyclopropyl-1-(1H-1,2,4-triazol-1-yl)butan-2-ol), Propiconazole (IUPAC name (2RS,4RS;2RS,4SR)-1-[2-(2,4-dichlorophenyl)-4-propyl-1,3-dioxolan-2-ylmethyl]-1H-1,2,4-triazole), Prothioconazole (IUPAC name (RS)-2-[2-(1-chlorocyclopropyl)-3-(2-chlorophenyl)-2-hydroxypropyl]-2,4-dihydro-1,2,4-triazole-3-thione), Epoxyconazole (IUPAC name (2RS,3SR)-1-[3-(2-chlorophenyl)-2,3-epoxy-2-(4-fluorophenyl)propyl]-1H-1,2,4-triazole), Paclobutrazol (IUPAC name (2RS,3RS)-1-(4-chlorophenyl)-4,4-dimethyl-2-(1H-1,2,4-triazol-1-yl)pentan-3-ol), Bitertanol (IUPAC name (1RS,2RS;1RS,2SR)-1-(biphenyl-4-yloxy)-3,3-dimethyl-1-(1H-1,2,4-triazol-1-yl)butan-2-ol), Triadimefon (IUPAC name (RS)-1-(4-chlorophenoxy)-3,3-dimethyl-1-(1H-1,2,4-triazol-1-yl)butan-2-one); and the systemic morpholines such as Spiroxamine (IUPAC name 8-tert-butyl-1,4-dioxaspiro[4.5]decan-2-ylmethyl(ethyl)(propyl)amine); Fenpropimorph (IUPAC name cis-2,6-Dimethyl-4-{2-methyl-3-[4-(2-methyl-2-propanyl)phenyl]propyl}morpholine or (2R,6S)-4-[3-(4-tert-butylphenyl)-2-methylpropyl]-2,6-dimethylmorpholine); Tridemorph (IUPAC name 2,6-Dimethyl-4-tridecylmorpholine) and the like.

Systemic fungicides include the QₒI fungicides or Strobilurins, such as Azoxystrobin (IUPAC name Methyl (2E)-2-(2-{[6-(2-cyanophenoxy)pyrimidin-4-yl]oxy}phenyl)-3-methoxyacrylate); Dimoxystrobin (IUPAC name (E)-2-(methoxyimino)-N-methyl-2-[α-(2,5-xylyloxy)-o-tolyl]acetamide); Enestrobin or Enestroburin (IUPAC name methyl-2-{2[({[3-(4-chlorophenyl)-1-methylprop-2-enylidene]amino}oxy)methyl]phenyl}-3-methoxyacrylate); Fluoxastrobin (IUPAC name (E)-{2-[6-(2-chlorophenoxy)-5-fluoropyrimidin-4-yloxy]phenyl}(5,6-dihydro-1,4,2-dioxazin-3-yl)methanone O-methyloxime); Pyraclostrobin (IUPAC name methyl N-{2-[1-(4-chlorophenyl)-1H-pyrazol-3-yl]oxymethyl]phenyl}(Nmethoxy) carbamate); picoxystrobin (IUPAC name methyl (2E)-3-methoxy-2-{2-[6-(trifluoromethyl)-2-pyridyloxymethyl]phenyl}acrylate.

Commercially available systemic fungicides of use in the invention include Azoxystrobin, Kresoxim-methyl (IUPAC name: methyl (2E)-2-methoxyimino-2-[2-[(2-methylphenoxy)methyl] phenyl]acetate), Metominostrobin (IUPAC name: (E)-2-(methoxyimino)-N-methyl-2-(2-phenoxy-phenyl)acetamide), Trifloxystrobin (CAS name: Benzene acetic acid, (E,E)-alpha(methoxyimino)-2-[[[[1-[3(trifluoromethyl)phenyl]ethylidene]amino] oxy]methyl]-,methylester) Pyraclostrobin (CAS name: methyl [2-[[[1-(4-chlorophenyl)-1H-pyrazol-3-yl]oxy]methyl]phenyl]methoxycarbamate), and Picoxystrobin (FRAC 2016) (CAS name: methyl(αE)-α-(methoxymethylene)-2-[[[6-(trifluoromethyl)-2-pyridinyl]oxy]methyl]benzene acetate); IUPAC name: methyl(E)-3-methoxy-2-{2-[6-(trifluoromethyl)-2-pyridyloxymethyl]phenyl}acrylate).

Where the non-arthropod pesticide is a systemically-acting herbicide it may be selected from systemic plant growth regulators such as systemically-acting phenoxy compounds, pyridines, systemically-acting auxin transport inhibitors such as phthalamates, and semicarbazones, systemically-acting amino acid biosynthesis inhibitors such as imidazolinones, sulfonylureas, sulfonylamino-carboynyl-triazolinones, sulphonamides, systemically-acting glycine derivatives such as glyphosates, systemically-acting fatty acid biosynthesis inhibitors such as aryloxyphenoxy propionates, cycohexadiones, and phenylpyrazolines, systemically-acting seedling growth inhibitors such as dinitroanilines, pyridines, benzamides, benzoic acids, carbamates, and nitriles, systemically-acting seedling growth inhibitors such as the chloroacetamides, oxyacetamides, thiocarbamates, phosphorodithioates, and acetamides, systemically-acting photosynthesis inhibitors (mobile I) such as triazines, triazinones, and uracils, systemically-acting photosynthesis inhibitors (mobile II) such as ureas, systemically-acting photosynthesis inhibitors (non-mobile; ‘rapid acting’) such as nitriles, benzothiadazoles, phenyl-pyridazines, systemically-acting cell membrane disruptors such as diphenyl ethers, N-phenyl-phthalimides, ozadiazoles, triazolinones, and bipyridyliums, systemically acting pigment inhibitors such as isoxazolidinones pyridazinones, isoxazoles, triketones and systemically-acting phosphorylated amino acids (N-metabolism disruptors) including amino acid derivatives such as phosphinic acids and mixtures of two or more thereof.

A formulation according to the invention may comprise an aqueous formulation or an oleaginous formulation. In a preferment, formulations of the invention are aqueous formulations.

The liquid formulations of the invention may be formulated as an aqueous formulation or as an oleaginous formulation, depending on design. Aqueous formulations may include surfactants selected from commercially available surfactants such as Agrosurf AEP66, Agrosurf SC22, Agrosurf SC100, Metasperse 500L, Tensiofix CGA213, Tensiofix DB08, Atlox 4913, Atlox 4914, Atlox 4915, Atlas 4916, Atlas g1086, Span 60, Tween 60, AEP66, Atlas g5002L, Silwet L77, Tween 80, Torpedo II, Fortune, Guard, Rhino, Biopower, and the like. Of these surfactants, preferred surfactants may be selected from AEP66, SC100, Atlas g1086, Metasperse 500L, Atlox 4913 and Atlas g5002L. Preferred combinations of two surfactants of use in the invention include combinations of AEP66 with SC100, Atlas g1086 with Metasperse 500L, and Atlox 4913 with Atlas g5002L.

Oleaginous formulations, that is to say oil-based formulations, may contain any oil suitable for use in the invention which may be selected from petroleum oils, such as paraffin oil, summer spray oils and winter spray oils known in the art, and vegetable oils such as rapeseed oil, soybean oil, sunflower oil, palm oil and the like. The oil formulations of the invention contain carrier particles as described herein below and these in turn may be admixed with flow agents such as hydrophobic precipitated silicas, for example Sipemat 383 DS, Sipemat 320, EXP 4350, and Sipemat D-17 and the like. Such free-flowing agents may be dispersed in oils, for example, for anti-foaming purposes.

Further additives or adjuvants may be added to herbicide formulations as commonly employed in the art and may be added to a spray mixture to improve application characteristics. Many commercially employed herbicides recommend using one or more adjuvants in the spray mixture. In general, there are two types of adjuvants: formulation adjuvants and spray adjuvants.

Formulation adjuvants may be added after the manufacturing process. These are designed to improve mixing, handling, effectiveness, and providing consistent performance and are not considered to play a role in the function of the systemic action of the herbicide. Spray adjuvants can be divided into special purpose adjuvants and activator adjuvants. Special purpose adjuvants include compatibility agents, buffering agents, antifoam agents, drift retardants, and others that widen the range of conditions for herbicide use but are not considered to play a role in the function of the systemic action of the herbicide. Activator adjuvants are commonly used to enhance post-emergence herbicide performance. These include surfactants, crop oil concentrates, vegetable oil concentrates, wetting agents, stickers-spreaders, N-fertilizers, penetrants, and others. Commonly used surfactants are nonionic surfactants and organo-silicones and are typically used at a rate of 0.25 percent v/v of spray mixture. Crop oil concentrates are 80 to 85 percent petroleum based plus 15 to 20 percent surfactant, while vegetable oil concentrates contain vegetable or seed oil in place of petroleum oil. Oil concentrates are typically included at a rate of 1 percent v/v of spray mixture. In general, oil concentrates provide better herbicide penetration into weeds under hot/dry conditions, but they are less likely to be used under normal growing conditions. Nitrogen fertilizers, such as UAN (a mixture of ammonium nitrate, urea, and water) and AMS (ammonium sulfate), may be used in combination with surfactants or oil concentrates for example, to reduce problems with hard water. Many blended adjuvants are available that include various combinations of special purpose adjuvants and/or activator adjuvants.

Additionally, the particles of liquid compositions of the invention may contain other components such as additives selected from UV blockers such as beta-carotene or p-amino benzoic acid, colouring agents such as optical brighteners and commercially available colouring agents such as food colouring agents, plasticisers such as glycerine or soy oil, antimicrobials such as potassium sorbate, nitrates, nitrites, propylene oxide and the like, antioxidants such as vitamin E, butylated hydroxyl anisole (BHA), butylated hydroxytoluene (BHT), and other antioxidants that may be present, or mixtures thereof. The skilled artisan will appreciate that the selection of such commonly included additives will be made depending on end purpose, and perceived need.

Naturally, the skilled addressee will appreciate that the electrostatic particles of the invention may comprise one or more systemic herbicides or one or more systemic fungicides, depending on design, the aerial parts to which the pesticides are applied, and end purpose.

The electrostatic particles of the invention may be made from any material suitable for carrying a systemically-acting pesticide of use in the invention and capable of holding an electrostatic charge. Such materials should be capable of being rendered into particulate form and able to carry added systemic pesticides. The electrostatic particles attach to the aerial plant parts via electrostatic forces sufficiently long enough to permit the aerial plant parts to take up the systemically-acting fungicide or systemically-acting herbicide therefrom. Typically, electrostatic particles of use in the invention are loaded with systemic pesticide, for example as described in the examples section (see below), and made into aqueous solutions ready for storage and/or immediate application to plant aerial parts.

The mass median diameter (MMD) of the particles is preferably less than 300 μm, preferably from 1 μm to 300 μm, more preferably from 1 μm to 200 μm. It is thought that the greater the surface area of particles of use in the invention in contact with the cuticle of aerial plant parts, the more efficient will be the transfer of systemic pesticide(s) to the plant. The diameter is generally chosen depending on the kind and size of nozzle used on the spraying device of the user. The mass median diameter is preferably between 1 μm and 100 μm, more preferable between 3 μm and 75 μm, and most preferably between 10 μm and 50 μm.

The types of plants that fungicidal formulations of the invention can be applied to include crop and horticultural plants of interest.

Suitable plants of commercial importance to which particles of the invention comprising systemically-acting fungicides may be applied include cereals such as rice (Oryza sativa), wheat (Triticum spp. such as T. aestivum) including species such as spelt (T. spelta), einkom (T. monococcum), emmer (T. dicoccum) and durum (T. durum), barley (Hordeum vulgare) including two row and six row barley, sorghum (Sorghum bicolor), millet species such as pearl millet (Pennisetum glaucum), foxtail millet (Setaria italica), proso millet (Panicum miliaceum) and finger millet (Eleusine coracana), oats (Avena sativa), rye (Secale cereale), Triticale (x Triticosecale), buckwheat (Fagopyrum esculentum); cotton plants of the family Malvaceae, typically Gossypium hirsutum (90% of world cotton production), Gossypium barbadense (8% of world cotton production), and Gossypium arboreum (2% of world cotton production); leguminous plants such as legume species of the family Fabaceae including species such as Alfalfa (Medicago sativa), Austrian winter pea (Pisum sativum), Berseem clover (Trifolium alexandrinum), Black medic (Medicago lupulina), Chickling vetch/pea (Lathyrus sativus) Cowpea (Vigna unguiculata), Crimson clover (Trifolium incarnatum), Field peas (Pisum sativum subsp. arvense), Hairy vetch (Vicia villosa), Horse beans (Vicia faba), Kura clover (Trifolium ambiguum), Mung beans (Vigna radiate), Red clover (Trifolium pratense), Soya beans (Glycine max), Subterranean clover (Trifolium subterraneum), Sunn hemp (Crotalaria juncea L), White clover (Trifolium repens), White sweet clover (Melilotus alba), Woolypod vetch (Vicia villosa spp. dasycarpa), Yellow sweet clover (Melilotus officinalis), Adzuki bean, (Vigna angularis, syn.: Phaseolus angularis), Broad bean (V. faba var. major), field bean (Vicia faba), Vetch (Vicia sativa), Common beans (Phaseolus vulgaris), including green beans, runner beans, haricot beans and the like, Chick pea (Cicer arietinum), Guar bean (Cyamopsis tetragonoloba), Hyacinth bean (Dolichos lablab), Lentil (Lens culinaris), Lima bean (Phaseolus lunatus), Lupin (Lupinus spp.), Mung bean (Vigna radiata, syn.: Phaseolus aureus), Pea (Pisum sativum), Peanut (Arachis hypogaea), Pigeon pea (Cajanus cajan), Tepary bean (Phaseolus acutifolius) and the like; Zea mays plants that is for food-related production or other industrial purpose such as starch production, bio-fuel manufacture, typically ethanol manufacture, animal fodder production and the like. Examples of Zea mays varieties used in industry include flour corn (Zea mays var. Amylacea); popcorn used as a food and in packaging materials (Zea mays var. Evert); flint corn used for hominy production (Zea mays var. Indurata); sweet corn used as a food (Zea mays var. saccharata and Zea mays var. Rugosa); Waxy corn used in producing food thickening agents, in the preparation of certain frozen foods, and in the adhesive industry (Zea mays var. Ceratina); Amylomaize maiz used in the production of biodegradable plastics (Zea mays); and striped maize used as an ornamental (Zea mays var. Japonica). Maize is also known as “com” and these two terms may be used interchangeably unless context demands otherwise. Field crop plants suitable for coating with compositions of use in the invention include those of the Crucifer family such as canola (B. campestris) and oilseed rape (B. napus); plants of the B. oleraceae such as types of cabbages, broccolis, cauliflowers, kales, Brussels sprouts, and kohlrabis; alliums including onion, leek and garlic. Other field crop plants include capsicums, tomatoes, cucurbits such as cucumbers, cantaloupes, summer squashes, pumpkins, butternut squashes, tropical pumpkins, calabazas, winter squashes, watermelons, lettuces, zucchinis (courgettes), aubergines, carrots, parsnips, swedes, turnips, sugar beet, celeriacs, Jerusalem artichokes, artichokes, bok choi, celery, Chinese cabbage, horse radish, musk melons, parsley, radish, spinach, beetroot for table consumption, linseed, sunflower, safflower, sesame, carob, coriander, mustard, grape, flax, dika, hemp, okra, poppy, castor, jojoba and the like; Fodder crop plants that may be grown as a stock feed for further processing such as in bio-fuel production, processed animal feed production, field planting for farm animal consumption and the like. Fodder crop plant species includes those of the Poaceae, including Lolium spp such as Italian Ryegrass, Hybrid Ryegrass, and rye grasses such as perennial ryegrass (Lolium perenne); Festuca species such as red fescue, fescue, meadow fescue, Tall fescue, Lucerne Fescue, and the forage herbs such as chicory, Sheep's Burnett, Ribgrass (also known as Robwort Plantain), Sainfoin, Yarrow, Sheep's Parsley and the like.

Pest plants to which particles of the invention comprising systemically-acting herbicides may be applied includes weeds that occur on land where plants of interest are grown and whose numbers require controlling. Such weeds are recognisable by the person skilled in the art.

There now follow figures and experimental data. It is to be understood that the teaching of the figures and the examples is not to be construed as limiting the invention in any way. The invention is illustrated with reference to the accompanying drawings.

### BRIEF DESCRIPTION OF THE DRAWINGS

FIG. 1 shows average number of live plants per replicate (a replicate is 10 plants) categorised at 0 and 21 DAT. N=10 for UTC and N=3 for Blank Entostat;

FIG. 2 shows height (Mean±SE) of wheat plants for each treatment recorded at each DAT. N=10 for UTC and N=3 for Blank Entostat;

FIG. 3 shows wheat plant growth (% mean growth by growth stage category);

FIG. 4 shows leaf number (Mean±SE) of each treatment recorded at each DAT;

FIG. 5 shows chlorosis level and mortality of wheat plant (% mean of total plants) categorised at 0 and 21 DAT for the three treatments;

FIG. 6 shows SPAD readings (Mean±SE) of wheat plants for each treatment recorded at each DAT;

FIG. 7 shows height (Mean±SE) of wheat plants for each treatment recorded at each DAT;

FIG. 8 shows the combined wet weight (Mean±SE) per plant present in each treatment at 21 DAT;

FIG. 9 shows micro-particles structures: (A) Mononuclear core and homogeneous shell microcapsule (core-shell microcapsule). (B) Poly-nuclear core and homogeneous shell microcapsule. (C) Mononuclear core and multi-shell microcapsule. (D) Polymer matrix (microsphere), where active is homogeneously or heterogeneously dispersed (Masuda 2011);

FIG. 10 is a graph showing the percentage azoxystrobin retention on maize seed; and

FIG. 11 is a graph showing the percentage Azoxystrobin detected in the foliage of 10 day old plants treated with either W3738 or W3800.

### EXAMPLES

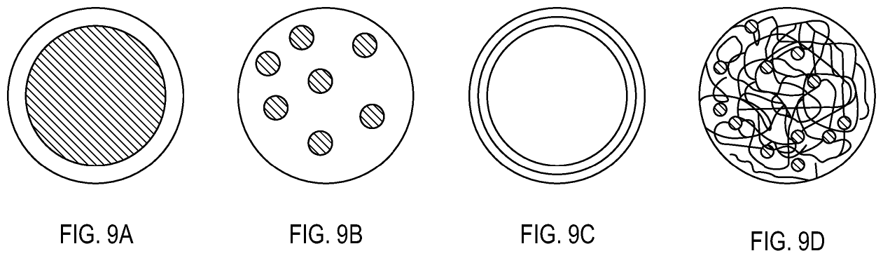

Micro-particles are widely used in controlled-release formulations, as these types of formulations are capable of delivering active ingredient slowly and continuously for a longer duration. These types of formulations are often cited as having an enhanced environmental profile as they can potentially reduce losses due to volatilisation, degradation and leaching, to maintain the bio-efficacy of the active ingredient (Sopenia et al. 2007; Nair et al. 2010; Gogos et al. 2012; Campos et al. 2014). How a pesticide is contained in a micro-particle can range from core-shell microcapsule, where the pesticide is enveloped in a capsule, to a microsphere, where the active is homogeneously or heterogeneously dispersed (FIG. 9).

The mechanism of controlled release can generally be explained as: (1) chemically-controlled (e.g. from bio-erodible systems), or (2) diffusion-controlled (i.e. based on a concentration gradient) (Lee and Good, 1987). In these types of formulations, only part of the active (pesticide) is immediately available, while the largest fraction is encapsulated in the inert matrix so that the pesticide is released more slowly.

Subsequent release of the active compound from the interior of the carrier system is governed by diffusive mass transfer, determined by the chemical characteristics of the carrier system and its interaction with the pesticide. As pesticides are often encapsulation specifically to slow down their release rate, it is reasonable to expect that where a pesticide is encapsulated, its bio-efficacy in the short term (knock down) will be lower compared to conventional formulations. For example Roy et al (2009) reported that when microspheres composed of sodium alginate and starch were used as a carrier system for the insecticide chlorpyrifos, 50% of free chlorpyrifos were released in only 1 day, while it took 5 days to release 50% of the insecticide from the encapsulated formulation. Wege et al (1999) reported that the knock down period of German cockroach, Blattella germanica, almost doubled (from 10.33 to 17.16 minutes) when a microencapsulated formulation of lambda-cyhalothrin was compared to an Emulsifiable Concentrate (EC).

Foliar uptake of pesticides is a complex process, depending on leaf surface characters of plants, physiochemical properties of the chemicals, types and concentration of the additives, and environmental conditions such as rain, wind and relative humidity (Wang and Liu, 2007). Movement of pesticides from the leaf surface into the plant can be directly through the stomata, or via diffusion across the waxy epidermis and through the cuticle. The stomatal uptake of chemicals was first reported by Field and Bishop (1988). It is now clear that the stomatal uptake of pesticides varies greatly with plant species, though this route of entry is more limited on grass species (Wang and Liu, 2007), where cuticular uptake (diffusion of the chemical directly through the cuticle) is the more dominant route-way.

All aerial surfaces of plants are covered by the cuticle. This waxy, waterproof layer not only prevents water loss, but also functions in defence by forming a barrier that resists physical damage and microbial invasion. Transport through the cuticle is thought to be a three stage mechanism: absorption into the cuticle, diffusion through the cuticle and finally desorption from the cuticle into the internal leaf cells (Schonherr and Baur, 1996). Wang and Liu (2007) concluded that the cuticle is incontestably the most important barrier for the penetration of pesticides. In fact, one of the main functions of spray adjuvants is to overcome or minimise the effect of leaf waxes and the cuticular barrier.

As, in a matrix formulation the rate of movement of the pesticide is dependent on diffusive mass transfer, it is expected that, when applied as a foliar spray, the additional distance which the pesticide needs to travel will result in less pesticide crossing the leaf cuticle (transcuticular/translaminar movement) and ultimately less pesticide being available to move through the plants vascular system (systemic activity). Where the carrier material is composed of waxes, which are known to act as a natural barrier, the expectation is that this diffusion process would be further impeded.

We thus demonstrate that, where pesticides are delivered as foliar sprays using the Entostat matrix encapsulation system, the encapsulated formulation is as effective as a conventional Suspension Concentrate (SC) formulation. This unexpected results is demonstrated for a herbicide (Quizalofop-p-ethyl for control of volunteer wheat) and a fungicide (Azoxystrobin for control of Zymoseptoria tritici (formerly Septoria tritici)). The compatibility of this technology is also demonstrated for the herbicide Prosulfocarb. This phenomenon is not dependent on the type of wax used, as both natural and synthetic waxes were employed effectively.

Quizalofop-p-ethyl (ethyl (2R)-2-[4-(6-chloroquinoxalin-2-yl)oxyphenoxy]propanoate) is an acetyl CoA carboxylase inhibitor (ACCase), which is used as a post emergence folia herbicide of annual and perennial grasses including volunteer cereals. ACCase herbicides are absorbed through the plant foliage and translocated to the plant growing point where they inhibit meristematic activity through inhibition of lipid biosynthesis (HRAC 2016). Symptoms include chlorosis of newly formed leaves and cessation of shoot growth. Plant death occurs 3 to 4 weeks after application.

Strobilurin is a naturally occurring compound produced by some Basidiomycete fungi (e.g. Strobilurus tenacellus) and myxobacteria (e.g. Myxococcus fulvus) (Bartlett et al 2001; Bertelsen et al 2001). Although too unstable to use as a fungicide in its natural form, knowledge that Strobilurin possessed a methyl (E)-3-methoxy-2-(5-phenylpenta-2,4-dienyl) acrylate moiety, led to the creation of the synthetic β-methoxyacrylates (Strobilurin) class of fungicides (Fernández-Ortuño et al 2010). Strobilurins are a member of the C3—quinone outside inhibitor (QoI)—fungicide mode of action (MOA) (FRAC 2016). They induce death by inhibiting the ubihydroquinone oxidation (Qo) centre of the cytochrome bc1 complex (complex III) to prevent electron transport during mitochondrial respiration (Sudisha et al 2005). To date, six Strobilurin fungicides have been commercialised: Azoxystrobin, Kresoxim-methyl, Metominostrobin, Trifloxystrobin, Pyraclostrobin, and Picoxydtrobin (FRAC 2016). Azoxystrobin (Methyl (2E)-2-(2-{[6-(2-cyanophenoxy)pyrimidin-4-yl]oxy}phenyl)-3-methoxyacrylate) acts as a systemic fungicide which has curative, translaminar and preventative action. The mode of action of azoxystrobin is to prevent the respiration of fungi due to the disruption of electron transport chain, preventing ATP synthesis (this occurs as the azoxystrobin binds to the Qo site of Complex III within the mitochondrion).

### EXPERIMENTAL SECTION

### Study 1

The purpose of these studies was to:
1. Investigate whether Entostat technology could be formulated with a number of herbicides and fungicides to develop novel sprayable Suspension Concentrate (SC) formulations.
2. To confirm blank Entostat SC formulation has no adverse effect on plant growth
3. Confirm that the Entostat formulated herbicides and fungicides deliver sufficient translaminar activity to be used to control the target organism (i.e. the active ingredient is not ‘trapped’ in the wax).

### Materials and Methods

Objective 1a Formulation of Electrostatic Waxes with a Herbicide

The compatibility of certain herbicides with carnauba and/or polyethylene wax was investigated. Two herbicides were evaluated in carnauba wax: Quizalofop-p-ethyl and Prosulfocarb. Quizalofop-p-ethyl was also evaluated in polyethylene wax. Formulations were produced as either powders (Quizalofop-p-ethyl and Prosulfocarb) or a suspension concentrate (Quizalofop-p-ethyl). Technical grade pesticide material (Active Ingredient) was sourced from ChemicalPoint (Germany). Formulation was by means of melt inclusion and the sample size was 500 g.

To formulate using melt inclusion, wax flakes were weighed into a copper pan and placed on a hot plate where the temperature was set to exceed the melting point of the wax by a minimum of 20° C. After a uniform melt was observed, pre-weighted Active Ingredient was added and the resulting mixture stirred with a spatula. The mixture was homogenised for 5 mins using a high sheer blender to achieve a good distribution of the Active Ingredient throughout the wax carrier matrix. After homogenisation, the mixture was allowed to cool at room temperature to form a solid product. Mechanical processing of the samples involved crushing, comminuting and jet micronisation. Jet micronisation is typically to 12-50 μm. Then the produced micro-powder is suspended in water with adequate surfactants as shown below. General recipe for a suspension concentrate is shown below:

| | Ingredient | % w/w |
|---|---|---|
| Phase 1 | Dispersed substance | 20-50 |
| | (Entostat Active | |
| | Ingredient: herbicide | |
| | selected from | |
| | Quizalofop-p-ethyl and | |
| | Prosulfocarb) | |
| | Surfactant 1: Wetter | 1-2 |
| | (polymeric wetting agent - | |
| | Lansurf AEP66) | |
| | Surfactant 1: Disperser | 1-5 |
| | (Polymeric disperser - | |
| | Metasperse 500L) | |
| | Antifoam (Silcolapse | 0.1-1 |
| | 5020) | |
| | Biocide (Preservative) | 0.1-0.2 |
| | (Proxel GXL) | |
| | Solvent- water | Top up to 100 |
| Phase 2 | Rheology modifier | 0.1-0.5 |
| | (Xanthan gum) | |
| | Antifreeze (propylene | 1-6 |
| | glycol) | |

The preparation process generally involves three phases:

Phase 1: Mix ingredients with homogenizer set to low RPM/shear, then high RPM/shear (10,000 rpm, 1-30 minute as needed). If needed transfer to Bead/Colloid mill (Med-High speed, 5-30 minutes as needed) to form a small particle dispersion.
Phase 2: Pre-mix Phase B ingredients to pre-disperse & pre-wet xanthan gum.
Phase 3: Add Phase 2 mixture to Phase 1 mixture while mixing at low, then high shear (10,000 rpm, 1 minute) to fully homogenise resulting material.

### Analysis of Quizalofopo-p-Ethyl in Entostat Powder

The active Quizalofop-p-ethyl was extracted from the wax matrix by ultrasonication into a suitable extraction solvent and analysed by High Performance Liquid Chromatography (HPLC) in order to achieve separation from the non-actives. Detection was by UV and quantitation was by internal standard.

### Chromatographic Conditions

| | |
|---|---|
| Column | Restek Ultra C18 5 μm 150.0 × 3.0 mm |
| Detector | UV 254 nm |
| | Slit 4 nm |
| Inlet System | Autosampler |
| | Draw speed 200 μl |
| | Eject speed 200 μl |
| | Low pressure set 5 bar |
| | High pressure set 600 bar |
| Injection Volume | 2 μL |
| Column oven | 40° C. |
| Mobile phase | Flow 0.6 ml/min |

| Time (mins) | % MeOH | % Water |
|---|---|---|
| 0 | 85.0 | 15.0 |
| 8.0 | 85.0 | 15.0 |
| 8.1 | 100.0 | 0.0 |
| 13.0 | 100.0 | 0.0 |
| 13.1 | 85.0 | 15.0 |
| 16.0 | 85.0 | 15.0 |

| | |
|---|---|
| Run time | 16 min. |
| Approximate | Internal standard 6.4 min. |
| Retention Times | Active components 4.3 min |

### Preparation of Standards

A standard of 5 mg/ml DCHP was made up by adding 0.25 mg of DCHP to 50 ml of 1:1 Methanol: Acetonitrile in a volumetric flask. A stock solution of 5 mg/ml Quizalofop-p-ethyl was made up by adding 0.25 mg of Quizalofop-p-ethyl to 50 ml of 1:1 Methanol: Acetonitrile in a volumetric flask. The required volumes of internal standard and Quizalofop-p-ethyl solution were pipetted into 5 extraction bottles and made up with 25 ml of 1:1 Methanol: Acetonitrile as above.

Sample Extraction from Powder

7-15 mg of sample formulation was weighed into a 60 ml bottle in triplicate and 25 ml of Dichloromethane solvent and the required volume of the internal standard were then added. The bottle was shaken vigorously for 5 seconds, placed in an ultrasonic bath, heated to 35° C. and sonicated for 5 mins. The bottles were removed from the heat and shaken vigorously to re-disperse the product. These two steps were repeated in triplicate. The extracts were left to settle for a minimum of 2 hours, after which time 1 ml of the dichloromethane extract layer was pipetted into a GC vial. The uncapped vials were placed into a sample concentrator set at 36° C. to allow the solvent to evaporate. This was repeated for Analytical Quality Control (AQC) samples.

To prepare the AQC samples 10 mg of blank matrix (Entostat) was weighed into a 60 ml bottle and the required amount of AQC solution and the internal standard were added to 25 ml of dichloromethane

The samples and AQC samples were redissolved by adding 1 ml of 1:1 Methanol: Acetonitrile capping, vortexing for 10-20 secs, heating them on the Techne sample concentrator for 4 mins at 40° C. and vortexing for 30 secs. The samples and AQC's were then taken up by glass pipette and transferred into a 2 ml syringe and dispensed through a 13 mm 0.45 μm nylon syringe filter into a new 1.5 ml GC vial. Each vial was capped ready for analysis by LC. 1 ml of each calibration standard was transferred directly to a labeled GC vial. All samples and standards were analyzed by HPLC.

### Calibration

A graph of peak area ratio PAR (peak area/peak area IS) (y axis) vs concentration (x axis) was constructed for the calibration standards. A linear trendline was used to find the line of best fit and display the coefficient of determination r² and the equation for the line y=mX+c.

### Samples

$$\text{Quizalofop} \text{-} \text{p} \text{-} \text{ethyl} \text{concentration mg/extract} = \frac{( PAR - c ) \times 25}{m \times 1000}$$

### Where:

PAR=peak area ratio
c=constant
m=slope
25=volume of extract

$$\text{AQC} \text{Quizalofop} \text{-} \text{p} \text{-} \text{ethyl} \text{µg/ml} = \frac{( PAR - c )}{m}$$

### Analysis of Prosulfocarb in Entostat Powder

The active Prosulfocarb was extracted from the wax matrix by ultrasonication into a suitable extraction solvent and analysed by capillary Gas Chromatography in order to achieve separation from the non-actives. Detection was by Flame Ionisation Detector and quantitation by internal standard.

### Chromatographic Conditions

| | |
|---|---|
| Column | Fused silica 30 m, 0.25 mm i.d. RXi5 or equivalent, |
| | film thickness 0.25 μm. |
| Detector | FID 350° C. |
| | hydrogen: 30 ml/min |
| | air: 300 ml/min |
| | nitrogen make up gas: 30 ml/min |
| Inlet System | Split/Splitless Inlet at 250° C. |
| | Split Ratio 10:1 |
| | Incorporating a pre-treated Split/Splitless liner |
| | Septum purge 3 ml/min |
| | Syringe Wash Solvent A: n-hexane |
| | Syringe Wash Solvent B: n-hexane |
| Injection Volume | 1 μl |
| Column oven | Initial: 60° C. |
| | Hold for 2 min. |
| | 45° C. min⁻¹ to 160° C. Hold 5.5 min |
| | 45° C. min⁻¹ to 250° C. |
| | 120° C. min⁻¹ to 325° C. |
| | Hold for 10 min. |
| Helium Carrier Gas | Constant flow 1.4 ml min⁻¹ |
| Run time | Approximately 23 min. |
| Approximate | Internal standard 11.1 min. |
| Retention Times | Active components 12.1 min |

### Preparation of Standards

A standard of 1 mg/ml methyl myristate was made up by adding 0.25 mg of 250 ml of n-hexane in a volumetric flask. A stock solution of 5 mg/ml Prosulfocarb was made up by adding 0.25 mg of Prosulfocarb to 50 ml of n-hexane in a volumetric flask. The required volumes of internal standard and Prosulfocarb solutions were pipetted into 5 extraction bottles and made up with 50 ml of n-hexane as above.

Sample Extraction from Powder

18-22 mg of sample formulation was weighed into a 60 ml bottle in triplicate and 50 ml of n-hexane solvent and the required volume of the internal standard were then added. The bottle was shaken vigorously for 5 seconds, placed in an ultrasonic bath, heated to 40° C. and sonicated for 5 mins. The bottles were removed from the heat and shaken vigorously to re-disperse the product. These two steps were repeated in triplicate. The extracts were left to settle for a minimum of 2 hours, after which time 1 ml of extract was pipetted into a GC vial. The uncapped vials were placed into a sample concentrator set at 36° C. to allow the solvent to evaporate. This was repeated for Analytical Quality Control (AQC) samples.

To prepare the AQC samples 20 mg of blank matrix (Entostat) was weighed into a 60 ml bottle and the required amount of AQC solution and the internal standard were added to 50 ml of n-hexane.

All samples and standards were analyzed by GC. The injection sequence was as follows.
Blank run—n-hexane
Calibration standards×5
Sample solutions (max. 12)
AQC×3
Calibration standard Low
Calibration standard High
Blank run—n-hexane
Standby

### Calibration

A graph of peak area ratio PAR (peak area/peak area IS) (y axis) vs concentration (x axis) was constructed for the calibration standards. A linear trendline was used to find the line of best fit and display the coefficient of determination r² and the equation for the line y=mx+c.

### Samples

$$\text{Prosulfocarb} \text{concentration mg/extract} = \frac{( PAR - c ) \times 50}{m \times 1000}$$

### Where:

PAR=peak area ratio
c=constant
m=slope
50=volume of extract

$$\text{AQC} \text{Prosulfocarb µg/ml} = \frac{( PAR - c )}{m}$$

### Analysis of Quizalofopo-p-Ethyl in Entostat Suspension Concentrate

Sample Extraction from the Suspension Concentrate

14-16 mg of well mixed Suspension Concentrate (weight required depends on the loading) was weighed into a 60 ml bottle in triplicate and the weight recorded. Approximately 125 mg of Sodium chloride was added to the bottle, along with the required amount of internal standard solution and 25 ml of Dichloromethane solvent. The bottle was swirled gently for 5 seconds, after which time it was place in an ultrasonic bath, heated to 35° C. and sonicated for 5 mins. Bottles were briefly removed from the bath, swirled gently to re-disperse the product and returned to the bath to continue to sonicate. These steps were repeated every 5 mins until 15 min has elapsed.

### Sample Transfer

After the extracts had settled at least 2 hours, 1 ml of dichloromethane extract layer was transferred into a GC vial. Uncapped vials were placed into a Techne sample concentrator set at 36° C. to evaporate the solvent. This was repeated for AQC samples.

The samples and AQC samples were re-dissolved by adding 1 ml of 1:1 Methanol: Acetonitrile, vortexing for 10-20 secs, heating them on the Techne sample concentrator for 4 mins at 40° C., capping and vortexing for 30 secs. The samples and AQC's were then taken up by glass pipette and transferred into a 2 ml syringe and dispensed through a 13 mm 0.45 μm nylon syringe filter into a new 1.5 ml GC vial. Each vial was capped ready for analysis by LC. 1 ml of each calibration standard was transferred directly to a labeled GC vial

To prepare the AQC samples approximately 15.0 mg of blank Suspension Concentrate was weighed into a 60 ml bottle. The required amount of AQC solution (calculated from the concentration calculator) was added, followed by, 125 mg of Sodium chloride, the internal standard and 25 ml of dichloromethane. Analysis was as described above for the powder formulation.

Objective 1B Formulation of Electrostatic Waxes with a Fungicide

The compatibility of the fungicide Azoxystobin with polyethylene wax was investigated. Formulations were produced as a powder and as a suspension concentrate. Technical grade pesticide material (Active Ingredient) was sourced from ChemicalPoint (Germany). Formulation was by means of melt inclusion and the sample size was 500 g.

### Objective 2 to Confirm Blank Entostat Sc has No Adverse Effect on Plant Growth

Test item type and Blank Entostat SC, contains 497.5 g/L Entostat (Carnuba contents: wax variant)
Test item rate: Blank Entostat SC was applied to plants at the rate of 1.47 L/ha in a water volume of 200 L/ha
Reference item: Untreated control, water
Application Interval: A single application was applied at the start of the study

Triticum aestivum (Spring wheat) variety KWS Alderon, supplied by KWS (Batch number C144). Twenty seeds were planted in half sized seed trays (23 cm length×17 cm width×23 cm depth) containing 1.5 L of John Innes No. 1 compost. After 7 days, the 10 least developed seedlings were removed. The remaining 10 seedlings were left to develop for a further 7 days until BBCH growth stage 12 was attained in the majority of plants. There were 15 replicates (trays) for the untreated controls and 3 replicates (trays) for the Blank Entostat SC treatment. Each tray contained 10 plants (initially 20 seeds) grown to BBSH growth stage “12”.

All test plants were grown (pre and post treatment) in growth tents (DP120 model) supplied by Secret Jardin, which were adapted for use in this study. Each growth tent contained 2 shelves. A Maxibright T5 120 cm fluorescent light was suspended 35 cm above each shelf and set to a 16:8 hour light dark cycle. All seed trays within the growth tents were placed on capillary matting lined watering trays. To water the plants, capillary matting was routinely soaked throughout the duration of the study. Data loggers were placed on each shelf of the tents to monitor environmental conditions for the duration of the study. The front of the tents were left open. The opening was sealed with thin netting held in place with Velcro. The netting prevented heat from the lamps building up in the tents during the study and prevented insect infesting the plants within.

A Cooper peggler CP3 20 L Knapsack sprayer was used to apply treatments. Pond liner with a protective underlay was used to create an outdoor spray area in which the knapsack sprays were conducted. The edges of the liner were upturned to prevent run-off. The seed trays were raised 30 mm upon stainless steel feet to prevent treatments being absorbed through the base of the trays. The total height the plants have been raised by (seed tray 60 mm+steel feet 30 mm) was accounted for in the swath width measurement used in the knapsack sprayer calibration. Post spraying plants were placed back into the growth tent after an appropriate drying off period.

Plants were visually inspected at 0, 7, 14 and 21 days after treatment (DAT) application for symptoms of phytotoxic effects as detailed in EPPO PP1/135 (4) Phytotoxic assessment. The 0 DAT data was collected prior to spraying. Symptoms of phytotoxicity to be compared between treatments at each time point and the methods of symptom assessment were as follows;
a) Mortality—Plants were classified as either alive or dead
b) Deformation—Possible stunting was investigated by recording plant height (mm) from soil vertically to the tallest leaf tip.

### Objective 3a to Confirm the Translaminar Activity of Quizalofop-P-Ethyl Formulated in Entostat

### Test & Reference Item Details

Test item type and Entostat Quiz SC, contains 497.5 g/L Entostat (Carnuba contents: wax variant) with the wax component formulated with Quizalofop-p-ethyl 52.0 mg/g (a.i. 2.64% w/w in SC).
Test item rate: Entostat quizalofop-p-ethyl was applied to plants at the same rate as the commercial standard Pilot Ultra counterpart.
   Dose=1.47 L/ha
   Water=200-400 L/ha
Reference item type 1) Pilot Ultra an emulsifiable concentrate (EC) and contents: containing 50 g/L quizalofop-P-ethyl (a.i. 5.1% w/w in SC).
   2) Untreated control, water
Reference item rate: 1) Pilot Ultra was applied as per the label recommended minimum dose rate, to control volunteer cereal weeds at the 2 leaf stage.
   Dose=0.75 L/ha
   Water=200-400 L/ha
   2) Water L/ha to match water used in Pilot Ultra spray.
Application interval: A single application was applied at the start of the study.

Triticum aestivum (Spring wheat) variety KWS Alderon, supplied by KWS (Batch number C144). Twenty seeds were planted in half sized seed trays (23 cm length×17 cm width×23 cm depth) containing 1.5 L of John Innes No 1 compost. After 7 days, the 10 least developed seedlings were removed. The remaining 10 seedlings were left to develop for a further 7 days until BBCH growth stage 12 was attained in the majority of plants. 150 plants were required per treatment. A total of 900 seeds (3 treatments, 15 repeats within each treatment consisting of 10 plants (initially 20 seeds) each) were sown at the start of the study. Horticultural canes and string were used to create a perimeter frame around the plants in each seed tray. The perimeter was to prevent cross contamination between plants in adjacent seed trays during later growth stages.

All test plants were grown (pre and post treatment) in growth tents (DP120 model) supplied by Secret Jardin, which were adapted for use in this study. Each growth tent contained 2 shelves. A Maxibright T5 120 cm fluorescent light was suspended 35 cm above each shelf and set to a 16:8 hour light dark cycle. All seed trays within the growth tents were placed on capillary matting lined watering trays. To water the plants, capillary matting was routinely soaked throughout the duration of the study. Data loggers were placed on each shelf of the tents to monitor environmental conditions for the duration of the study. The front of the tents were left open. The opening was sealed with thin netting held in place with Velcro. The netting prevented heat from the lamps building up in the tents during the study and prevented insect infesting the plants within.

Each of the four propagator tents contained 12 water trays across two shelves (six water trays per shelf). Each of the water trays contained a single seed tray. The experiment required 45 water trays. The allocation of the water trays across the tents was randomised. Each seed trays contained 10 seedlings grown to BBSH growth stage “12”. Each water tray was considered to be 1 replicate, consisting of 10 seedling. This allowed for 15 replicates per treatment (Untreated control, Entostat Quiz SC or Pilot Ultra).

A Cooper peggler CP3 20 L Knapsack sprayer was used to apply treatments. Pond liner with a protective underlay was used to create an outdoor spray area in which is the knapsack sprays were conducted. The edges of the liner were upturned to prevent run-off. Seed trays were placed on top of the matting in 3 rows containing 5 seed trays per row. The seed trays were raised 30 mm upon stainless steel feet to prevent treatments being absorbed through the base of the trays. The total height the plants have been raised by (seed tray 60 mm+steel feet 30 mm) was accounted for in the swath width measurement used in the knapsack sprayer calibration. Post spraying plants were placed back into the growth tent after an appropriate drying off period.

Plants were visually inspected at 0, 7, 14 and 21 DAT application for symptoms of phytotoxic effects as detailed in EPPO PP1/135 (4) Phytotoxic assessment. The 0 DAT data was collected prior to spraying. Symptoms of phytotoxicity to be compared between treatments at each time point and the methods of symptom assessment were as follows;
1. Modification in the development cycle—any inhibition or delay in emergence or growth. Two methods were used to assess growth stage:
   a) Each plant was assigned a BBCH growth stage, the growth stages were grouped as shown in Table 1.
   b) The starting growth stage of the plants was BBCH growth stage 12. At each time point, the total number of leaves present was counted and recorded as a single number to denote plant growth for each plant.

TABLE 1
BBSH growth stage grouping to indicate increased growth within the
assigned nomenclature

| BBCH Growth stage | Assigned nomenclature |
|---|---|
| 11 and 12 | Growth = 0 |
| 13 and 21 | Growth + 1 |
| 14 and 22 | Growth + 2 |
| 15 and 23 | Growth + 3 |
| 16 and 24 | Growth + 4 |

2. Modification in colour including necrosis—Individual plants were assessed for modification in colour or necrotic tissue. Two methods were used to make this assessment:
   c) A visual scale was used to classify the plants as being: Alive or Dead, or displaying; Slight chlorosis, Moderate chlorosis or Strong chlorosis.
   d) Chlorophyll meter SPAD-502 plus was used to measure the chlorophyll content from the midpoint of the newest leaf to emerge on each plant per seed tray.
3. Deformation—Deviations from the normal plant shape in the form of stunting was monitored by recording plant height (mm) from soil vertically to the tallest leaf tip.

At 21 DAT after the phytotoxicity data had been collected, the section of plant material protruding from the soil was removed and weighed. The mean wet weight (g) per plant per seed tray was calculated.

Statistical analysis was performed using R version 3.3.1
1) Modification in the development cycle—
   a. The proportion of plants at BBCH growth stages 11 and 12 (Growth=0) at the 21 DAT time point were analysed. At 21 DAT all untreated control plants had grown, yielding 0% displaying Growth=0 so were removed from the analysis. Plants treated with Entostat Quiz SC or Pilot Ultra were compared in a chi squared test.
   b. The 21 DAT leaf number data was log transformed and normality within each treatment was confirmed using a Shapiro-Wilk normality test. The transformed data was modelled as a function of treatment type (Untreated Control, Entostat Quiz SC or Pilot Ultra) and analysed using ANOVA. Tukey multiple comparison of means post hoc testing assessed differences between the treatments.
2) Plant modification in colour including necrosis—
   a. The proportion of “Dead” plants at the 21 DAT time point were analysed. 0% of untreated control plants were classified as dead at 21 DAT so removed from the analysis. Plants treated with Entostat Quiz SC or Pilot Ultra were analysed using a chi squared test.
   b. The 21 DAT SPAD data was log transformed and normality within each treatment was confirmed using a Shapiro-Wilk normality test. The transformed data was modelled as a function of treatment type (Untreated Control, Entostat Quiz SC or Pilot Ultra) and analysed using ANOVA. Tukey multiple comparison of means post hoc testing assessed differences between the treatments.
3) Deformation—the effect of treatment (Untreated Control, Entostat Quiz SC or Pilot Ultra) on the 21 DAT plant height data was analysed using Kruskal-Wallis rank sum test. Post hoc testing was pairwise comparisons using Tukey and Kramer (Nemenyi) test with Tukey-Dist approximation for independent samples.
4) Plant wet weights were tested for normality within each treatment using a Shapiro-Wilk normality test. Plant wet weight was modelled as a function of treatment type (Untreated Control, Entostat Quiz SC or Pilot Ultra) and analysed using ANOVA. Tukey multiple comparison of means post hoc testing assessed differences between the treatments.

The BBCH growth stages were analysed in groups which reflected their deviations from the initial starting growth stage as described in Table 1 (above).

### Objective 3b to Confirm the Translaminar Activity of Azoxystrobin Formulated in Entostat

### Test & Reference Item Details

Test item type and Entostat SC contains in 300 g/L Entostat (Polyethylene contents: wax variant), with the wax component formulated with 81.8 g/L Azoxystrobin (8.18% w/w Azoxystrobin in SC)
Test item rate: The Entostat formulation was applied at a rate 2.68 L/ha delivering 219 g a.i/ha (which delivers Azoxystar's maximum label amount of active ingredient).
Reference item type Azoxystar—SC Strobilurin fungicide containing 249 g/L and contents: of Azoxystrobin (22.9 w/w Azoxystrobin in SC).
Reference item rate: Azoxystar was applied at the maximum recommended label rate (0.88 L/ha delivering 219 g a.i/ha)
Application interval: Once at wheat growth stage 12

200 square plastic pots (7×7×8 cm) were filled with J. Arthur Bower No. 1 seedling compost and drenched with tap water. Into each pot six spring wheat (T. aestivum cv. KWS Kielder) seeds were double sown. The pots were placed within four Secret Jardin 120 growth tents in a fully randomised block design of 40 blocks (5 pots per block). All plants were grown under a light, temperature and relative humidity (RH) regime of 16:8 light/dark, 20° C./17° C. and 80% RH. Pots were watered via capillary matting with tap water when required. No additional nutrients were supplied throughout the study. Fourteen days after sowing the six plants in each pot were reduced to three of uniform size.

Z. tritici spores were cultured using the method of Rudd (Rothamsted Research, personal communication). Spores were frozen (−20° C.) in a 1:1 sterilized glycerol: deionised water solution until use. To establish a culture, 30 μl of glycerol spore suspension was pipette onto a potato dextrose agar (PDA) plate and spread using a sterile inoculation loop (SIL). Sealed plates were incubated at 16° C.

The study consisted of three independent variables (formulation and timing of fungal inoculation (days after fungicide treatment (DAFT)) and five dependent variables (spore germination, hyphal length, fungal lesion number, pycnidia number, and percentage of fungal damage). A total of 6 treatment combinations were tested (Table 2). Each treatment was replicated 20 times.

At GS 12 the wheat receive a treatment of fungicide (Table 2). GS 12 occurred approximately 21 days after sowing under the aforementioned conditions. Formulations were applied in approximately 200 L/ha of water (a volume of water used to apply a similar Azoxystrobin product Amistar, Syngenta) using a knapsack sprayer. The sprayer was fitted with a red Hypro 800 evenspray (FE80/1.6/3) nozzle, a filter bigger than 50 mesh, and set to a pressure of 250,000 pa (2.5 bar).

TABLE 2
List of experimental treatments where wheat plants were exposed
to the pathogen Z. tritici.

| | | A.I in | | |
|---|---|---|---|---|
| | Formulation | formulation | Azoxystrobin | Application |
| DAFT | (% of label rate) | (g/L) | dose (g a.i/ha) | rate (L/ha) |
| 1 | Untreated (0%) | 0 | 0.000 | 0.00 |
| 1 | Azoxystar (100%) | 249 | 219.0 | 0.88 |
| 1 | Entostat (100%) | 81.8 | 219.0 | 2.68 |
| 21 | Untreated (0%) | 0 | 0.000 | 0.00 |
| 21 | Azoxystar (100%) | 249 | 219.0 | 0.88 |
| 21 | Entostat (100%) | 81.8 | 219.0 | 2.68 |

DAFT = Days after fungal treatment

1 DAFT, every pot from two of the growth tents were inoculated with Z. tritici. 21 DAFT, every pot from the remaining growth tents were inoculated. Seven days prior to fungal inoculation Z. tritici was cultured onto six PDA plates. From these six plates a 100 ml spore suspension, containing approximately 6×10⁷ spores and 0.05% tween, was produced. 5 ml of spore suspension was applied to each pot until run off with a 100 ml atomizer (40 presses of the atomizer=5 ml). Each pot was covered with two clear perforated polyethylene bags and enclosed in growth tents (lights off) for 72 hours and frequently misted with deionised water to achieve 100% RH and a temperature of 17° C. After 72 hours the bags were removed, the tent door opened, and the light regime of 16:8 light/dark reinstated. A string fence was placed around each pot to keep the plants upright and free from water damage. Pots were watered via capillary matting with tap water when required. No additional nutrients were supplied throughout the study.

Seven days after inoculation one plant from each pot had two inoculated leaves removed. We consider these to be the ‘original leaves’. From each leaf a 10 mm×5 mm sample representing the greatest degree of fungal damage was taken. The sample were placed in a capped vial containing 2 ml 1:1 v/v acetic acid: ethanol solution and heated in a water bath at 60° C. for 1 hour. Once the sample has been removed from the acetic acid: ethanol solution it was rinsed with deionised water. The sample was stained in a capped vial of 1 ml 1% lactophenol blue solution (10 μl lactophenol blue solution in 990 μl deionised water) at room temperature for 16 hours. The stained sample was mounted on a glass slide for examination under a light microscope.

Taking a diagonal transect across the leaf (top left to bottom right), germination was recorded for ten spores (minimum). Germinated spores are those with a germ tube that is at least half the length of the width of the spore. Again taking a diagonal transect across the leaf, the length of ten hyphae (minimum) was measured in accordance with the method of Olson (1950).

One plant in each pot was left until 28 DAFT to allow time for fungal lesions to develop (if fungicide is ineffective). At this stage the leaves on the plant included the ‘original leaves’ and the ‘new growth’. On each plant there were 2-3 ‘original leaves’ and >10 ‘new leaves’. The fungal lesions were evaluated by (1) counting the number of lesions bearing pycnidia, (2) counting the total number of pycnidia, and (3) estimating the percentage area of the leaf damaged by Z. tritici. Values for ‘original leaves’ and ‘new growth’ were collected separately.

Germinated spore counts and proportion leaf damage was analysed using binomial generalized linear models. Hyphae length was normalized and analysed using a two-way ANOVA. A Poisson generalized linear model was used to assess the number of fungal lesions and pycnidia. All data was analysed using R 3.3.1 statistical software.

### Results

Objective 1a Formulation of Electrostatic Waxes with a Herbicide

### Loading Rates

Where the representative herbicide was Quizalofop-p-ethyl, in the study using carnuba wax as the carrier, theoretical loading of the Quizalofop-p-ethyl Active Ingredient in the SC was 25 mg/g ((2.5% w/w). In the study using polyethylene wax as the carrier, theoretical loading of the Quizalofop-p-ethyl Active Ingredient in the SC was 50 mg/g (5% w/w). The percentage of the theoretical loading (nominal concentration) actually detected (validated) in the formulations ranged from 96-104% (Table 3).

TABLE 3
Nominal and validated concentrations of Quizalofop-p-ethyl in wax

| | | Nominal | | (% | |
|---|---|---|---|---|---|
| Formulation | | Concentration | (mg/g) | W/W) | % of Nominal |
| Type | Wax | Al (mg/g) | Al | Al | concentration |
| Powder | PE | 200.0 | 192.40 | 19.24 | 96 |
| Suspension | C | 25.0 | 25.88 | 2.59 | 104 |
| Concentrate | | | | | |
| Suspension | PE | 50.0 | 50.40 | 5.04 | 101 |
| Concentrate | | | | | |

### Loading Rates

Where the representative herbicide was Prosulfocarb, in the study using carnuba wax as the carrier, theoretical loading of the Prosulfocarb Active Ingredient in the wax powder (solid state material) was 50 mg/g (5% w/w). The percentage of the theoretical loading (nominal concentration) actually detected (validated) in the formulations ranged was 103% (Table 4).

TABLE 4
Nominal and validated concentrations of Prosulfocarb in wax

| | | Nominal | | | |
|---|---|---|---|---|---|
| Formulation | | Concentration | (mg/g) | (% W/W) | % Nominal |
| Type | Wax | Al (mg/g) | Al | Al | conc. |
| Powder | C | 50 | 51.51 | 5.15 | 103 |

Objective 1b Formulation of Electrostatic Waxes with a Fungicide

### Loading Rates

Where the representative fungicide was Azoxystobin, the theoretical loading of the Azoxystobin Active Ingredient in the wax powder using polyethylene wax as the carrier ranged from 273-400 mg/g. The percentage of the theoretical loading (nominal concentration) actually detected (validated) in the formulations ranged from 101-111% (Table 5). The theoretical loading of the Azoxystobin in the Suspension Concentrate was 82.5 mg/g, with a validated loading of 99%.

TABLE 5
Nominal and validated concentrations of Azoxystobin in wax

| | | Nominal | | (% | |
|---|---|---|---|---|---|
| Formulation | | Concentration | (mg/g) | W/W) | % of Nominal |
| Type | Wax | Al (mg/g) | Al | Al | concentration |
| Powder | PE | 273.0 | 278.17 | 27.8 | 101.5 |
| Powder | PE | 400.0 | 445.01 | 44.50 | 111.3 |
| Suspension | PE | 82.5 | 81.83 | 8.18 | 99.1 |
| Concentrate | | | | | |

### Objective 2 Confirm Blank Entostat Sc has No Adverse Effect on Plant Growth

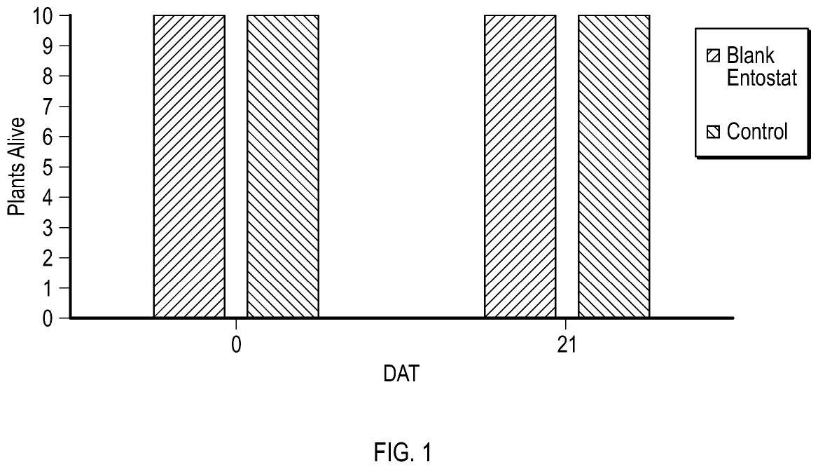

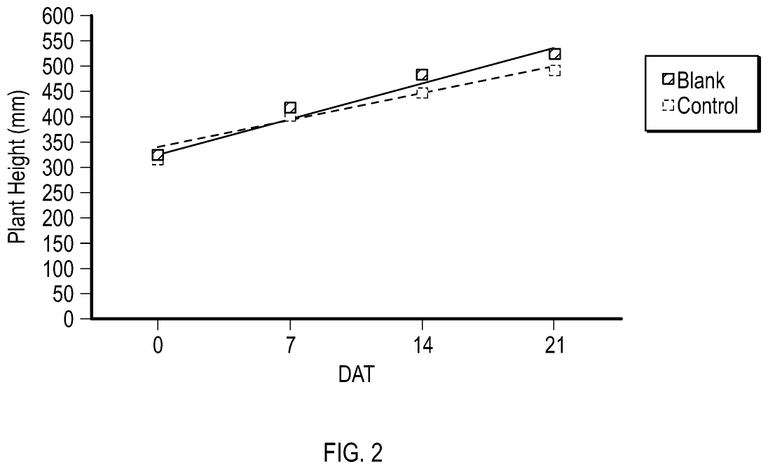

Application of a blank Entostat SC formulation (no pesticide) did not adversely affect any of the measures of plant growth in wheat. When plants were assessed 21 DAT, the number of live plants in each of the replicates was identical (10) in both the untreated controls and where blank Entostat was applied (FIG. 1). In the untreated controls, plants grew, on average, from 324.8 mm to 491.7 mm (51% increase). In the blank Entostat treatment the corresponding increase was from 315.8 mm to 524 mm (66% increase) (FIG. 2).

### Objective 3a to Confirm the Translaminar Activity of Quizalofop-P-Ethyl Formulated in Entostat

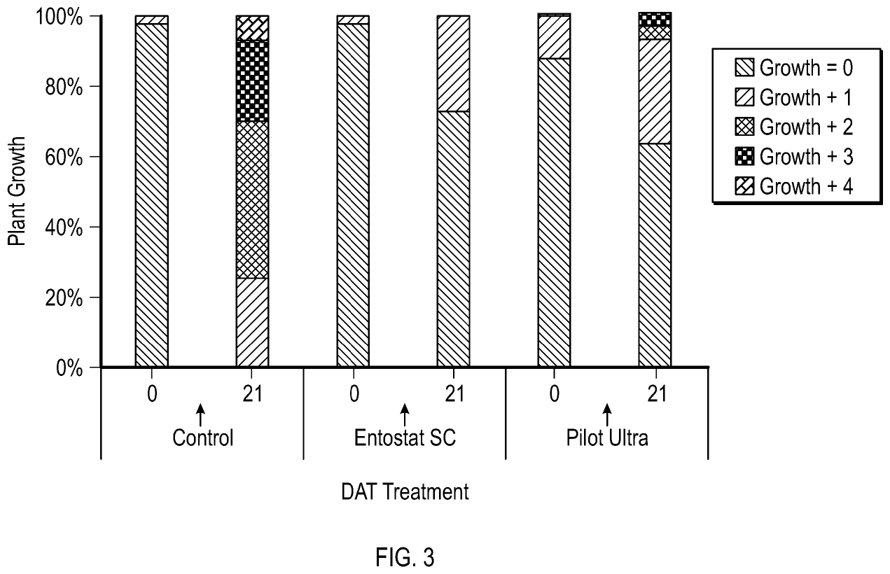

Growth Stage—BBCH scale: There was no significant difference between the numbers of plants which remained at BBCH Growth stage 12 (Growth=0) at 21 DAT between the Entostat Quiz SC and Pilot Ultra treatments (X²=1.549, d.f.=1, p=0.2133) (FIG. 3).

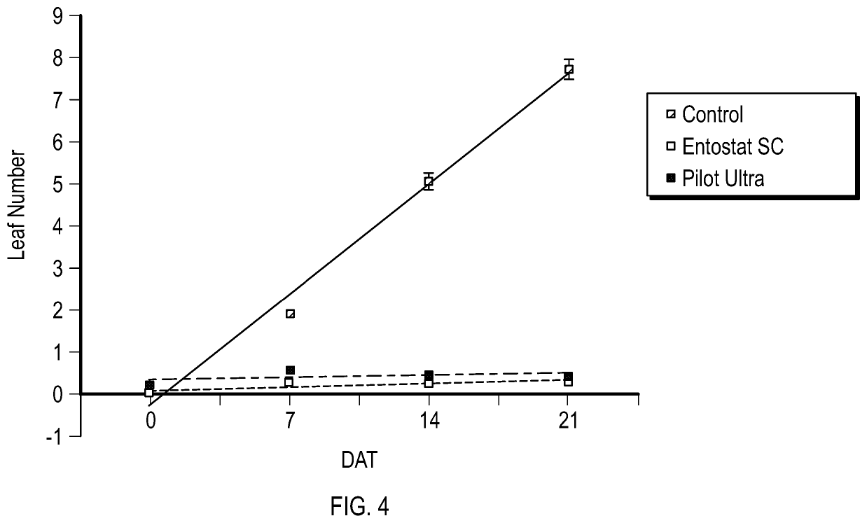

Growth Stage—Leaf number: At 21 DAT, treatment significantly affected the number of leaves which had developed on wheat (F_{(2, 41)}=160.4, p<0.001). Both Entostat Quiz SC and Pilot Ultra exhibited significantly lower leaf numbers than the untreated control plants (t=−2.94, p<0.001 and t=−2.80, p<0.001, respectively). Post hoc testing showed no significant difference between the leafiness of Entostat Quiz SC and Pilot Ultra treated plants (p=0.75) (FIG. 4).

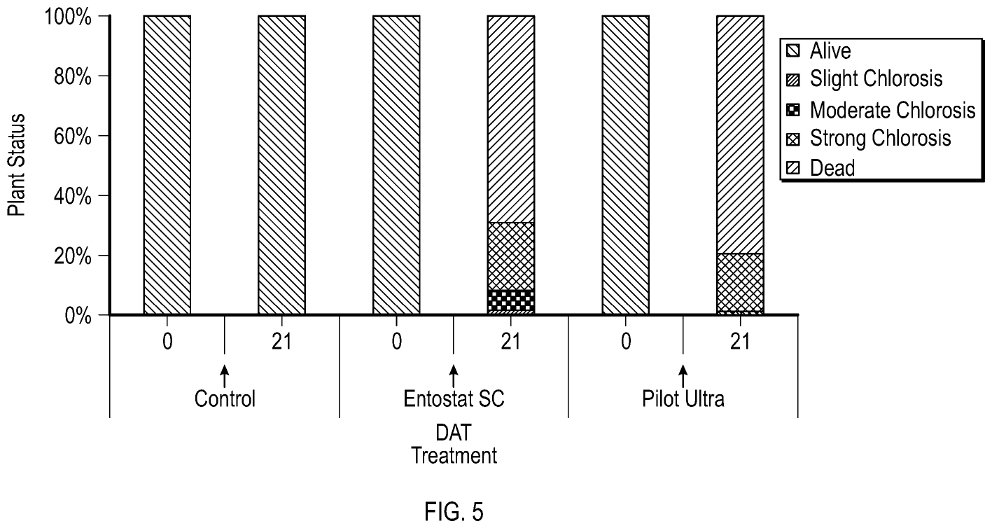

Colour and necrosis: There was no significant difference between the numbers of dead plants at 21 DAT between the Entostat Quiz SC and Pilot Ultra treatments (X²=2.397, d.f.=1, p=0.122) (FIG. 5).

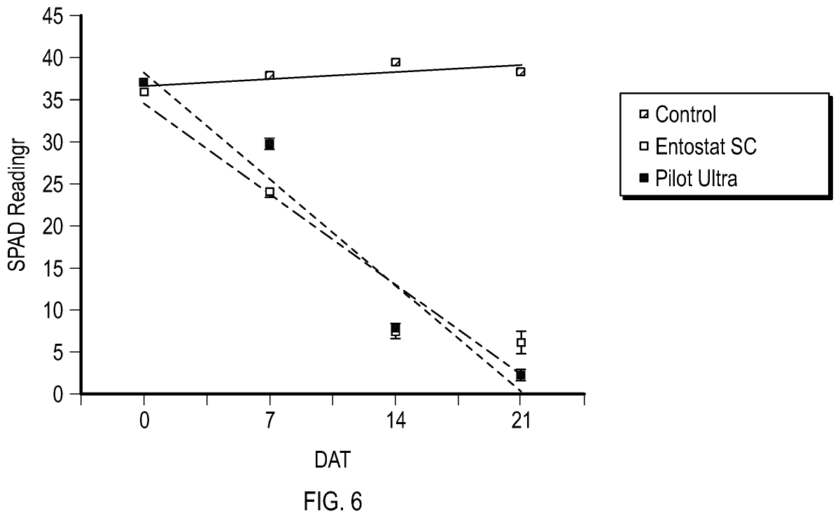

SPAD meter chlorophyll content: At 21 DAT, treatment type significantly affected the chlorophyll content of the wheat (F_{(2, 33)}=74.4, p<0.001). Both Entostat Quiz SC and Pilot Ultra exhibited significantly less chlorophyll than the untreated control plants (t=−2.31, p<0.001 and t=−2.57, p<0.001, respectively). Post hoc testing showed no significant difference between the chlorophyll content of Entostat Quiz SC and Pilot Ultra treated plants (p=0.58) (FIG. 6).

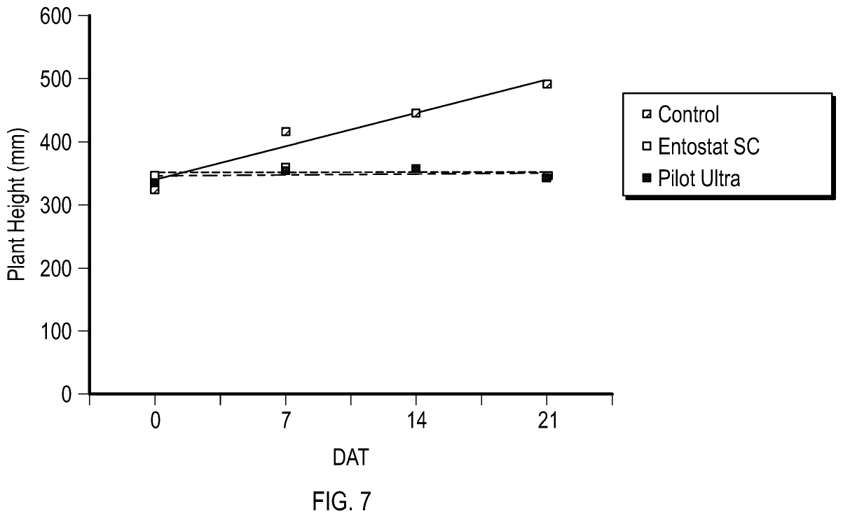

Plant Height: At 21 DAT plant heights were significantly different between the treatments (X2=278.06, d.f.=2, p<0.001). Entostat Quiz SC and Pilot Ultra were significantly smaller than the untreated control plants (p<0.001 and p<0.001 respectively), but did not differ from each other (p=0.95) (FIG. 7).

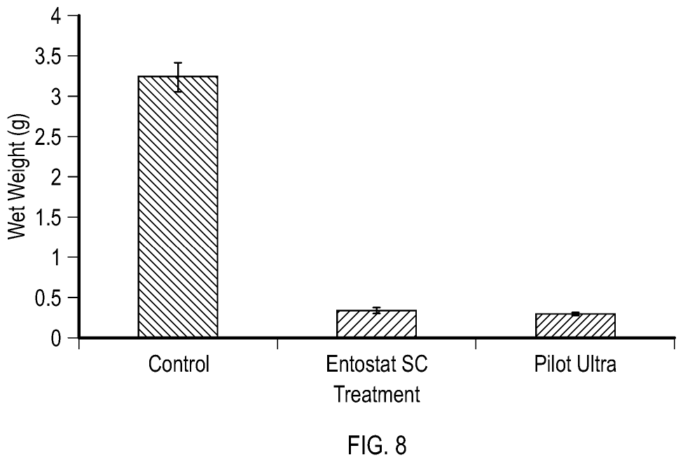

Plant wet weight: The wet weight of the plants was significantly affected by treatment (F_{(2, 41)}=247.2, p<0.001). Both Entostat Quiz SC and Pilot Ultra were significantly lighter than the untreated control plants (t=−2.90, p<0.001 and t=−2.95, p<0.001, respectively). Post hoc testing showed no significant difference between the wet weights of Entostat Quiz SC and Pilot Ultra treated plants (p=0.94) (FIG. 8).

Average temperatures in the growth tents over the course of the trials ranged from 23.8 to 28.9° C. Average relative humidity in the growth tents over the course of the trials ranged from 51.7 to 60.0%.

### Objective 3b to Confirm the Translaminar Activity of Azoxystrobin Formulated in Entostat

If the fungicide is ‘trapped’ in the wax, then the expectation is that at 28 days after fungal treatment (28 DAFT) stage, only ‘original leaves’ will be protected (i.e. low number of lesions and low percentage of area of damage by Z. tritici), since only these ‘original leaves’ come into direct contact with the fungicide during spraying. ‘New growth’ produced in the period between fungicide application and the 28 DAFT sampling is not directly exposed to the fungicide so a reduction in the level of fungal damage on these leaves, compared to untreated control plants confirms that the fungicide migrates out of the Entostat wax, across the plant cuticle (transcuticular/translaminar movement) and through the plants vascular system (systemic).

### DISCUSSION

Systemicity of fungicides and herbicides in leaves is dependent upon both transcuticular movement and subsequent translocation within the lamina (Solel and Edgington, 1973). The primary objective of this study is to determine when Entostat could be used as a delivery system for translaminar pesticides applied to plant foliage (pesticide in wax). The second objective of this study is to determine the phytotoxicity of Entostat only (no pesticide) to wheat, when applied as a foliar spray. The final aim of this study is to determine whether applied chemistries exhibit pesticidal activity when delivered via the Entostat formulation.

At 21 DAT there is no loss to the Quizalofop-p-ethyl's mode of action efficacy when formulated within Entostat SC compared to the commercial standard Pilot Ultra. The herbicidal Entostat SC is able to kill target weeds with the same efficacy as a market standard. Plant death is driven by lipid synthesis inhibition within the meristematic tissue which also effects cell elongation resulting in stunted plant growth. We demonstrate that Entostat SC prevents increases in plant height with the same efficacy as Pilot Ultra and leaf development is also halted. Comparison with untreated control plants shows that the chlorophyll content in the Entostat SC and Pilot Ultra treated plants is also decreased. The lack of an effect when blank Entostat is applied confirms that the phytotoxic effects are attributable to the pesticide, rather than the carrier alone.

Prior to undertaking this work, the expectation was that formulation of pesticide in Entostat wax would in some way inhibit the uptake/activity of the pesticides, given the fact that plant waxes in the cuticle have a protective function, acting as a barrier to the uptake of pesticides. The novel finding is that pesticides formulated in Entostat wax are as biologically active as conventional formulations, which have a shorter diffusion pathway.

### Study 2

### Objective

The first objective of this study was to identify the optimum application rate of a dry powder seed treatment formulation. The optimum application rate in this study is defined as the dry powder application rate and formulation type that confers greatest retention of Azoxystrobin on the surface of maize seed while yielding the least amount of powder displaced by mechanical stress.

### Introduction

This study aims to demonstrate systemic activity of a fungicide applied as a dry seed treatment. Translocation has been demonstrated using insecticide acetamiprid as a seed treatment. Previous work highlighted a need to investigate further the optimum application rate for a dry powder seed treatment formulation; in which retention on a seed of an active ingredient formulated in a dry powder seed treatment is maximised, while powder loss due to mechanical stress is minimised. Study 1 showed higher percentage loading levels of acetamiprid were observed on seeds treated with lower application rates, but a 10 fold decrease in powder application was required to increase relative percentage loading from 52% to 80%. This study investigated two Azoxystrobin dry powder formulations at three application rates. Treatments were applied to maize seeds. Seed samples were taken before and after mechanical stress and Azoxystrobin residues calculated.

### Materials and Methods

### Test Item Details

Test item type and 1. Polyethylene Entostat (W3800) containing 499 mg/g contents: Azoxystrobin fungicide.
   2. Carnauba Entostat (W3738) containing 435 mg/g Azoxystrobin fungicide.
Test item rate: When using a commercial standard biological efficacy in maize is observed at 6.259 μl a.s./kg seed. W3800 and W3738 were applied at 1×100 (Low), 1×10′ (Medium) and 1×10² (High) of that commercial standard a.s. rate Table 1.
Application interval: Single application at the start of the study
Supplier: Entostat, Exosect, UK
   Azoxystrobin, Albaugh, USA.
Storage: Pesticide cabinet in formulation laboratory, Exosect

TABLE 1
Application details for formulations W3800 and W3748.

| | | Azoxystrobin | Formulation |
|---|---|---|---|
| Formulation | Application | application rate (g per | application rate |
| type | rate | kg seed) | (g/kg seeds) |
| W3800 | Low | 0.006259 | 0.0125 |
| W3800 | Medium | 0.06259 | 0.125 |
| W3800 | High | 0.6259 | 1.25 |
| W3738 | Low | 0.006259 | 0.0144 |
| W3738 | Medium | 0.06259 | 0.144 |
| W3738 | high | 0.6259 | 1.44 |

### Reference Item Details

The commercial standard label referenced in this study is Agri Star, a fungicide seed treatment containing 9.6% (w/v) Azoxystrobin.

### Test System

Treatments were applied to untreated maize seeds (Table 2).

TABLE 2
Seed details

| Seed Type | Variety | Source | Batch Number | TGW (g) |
|---|---|---|---|---|
| Maize | MAS10C | Bright Seeds | B678 | 316 |

### Experimental Design

The independent factors were, dry powder seed treatment formulation type (W3800 and W3738) and Azoxystrobin application rate (Low, Medium, and High). Residues of the active ingredient Azoxystrobin recovered from maize before and after mechanical stress were quantified. Each treatment will be replicated ten times. Work involving the Heubach Dustmeter was conducted according to know standard procedures.

### Pre-Experimental Procedures

Seeds were equilibrated in incubator 308 at 20° C.±2° C. and at 50%±10% relative humidity for at least 48 hours prior to testing.

### Experimental Procedures

### Treatment of Test System

Treatments were weighed into sterile 1 L Duran bottles along with 500 g of maize seeds. The treatments were homogenized for 30 seconds by gently agitating using the Stuart Rotator with MIX2040 attachment. 50 maize seeds were removed from each batch, weighed, and placed in a bioassay jar for pre mechanical stress quality control analysis. One 100 g sample were removed from each batch.

The 100 g sample was mechanically stressed in the Heubach Dustmeter (Heubach GMbh, Heubachstrasse7, 38685 Langelsheim), following the procedures outlined in TDRF311. Work involving the Heubach Dustmeter was conducted between 23° C. and 29° C. and 30% and 70% relative humidity in Bioassay Room 2. After the cycle, treated seeds were removed from the rotating drum. 50 maize seeds were removed from each batch, weighed, and placed in a bioassay jar for post mechanical stress quality control analysis.

### Sampling/Measurement Regime

Azoxystrobin present on the seed samples taken before and after Heubach mechanical stress were analysed using gas chromatography with electron capture detector (GC-ECD). From these values the percentage change of Azoxystrobin a.s. retained by the seeds mechanical stress was calculated.

### Environmental Monitoring

Data loggers monitored temperature and relative humidity in the equilibration incubator 308 and in bio room two during the Heubach process.

### Statistical Analysis

Percentage Azoxystrobin retained on maize seed after mechanical stress was modelled using R (version 3.3.1). After testing for normality using a Shapiro-Wilk normality test, ANOVA was used to analyse the data linear model. Percentage Azoxystrobin retention was modelled as a function of the factors formulations type (W3800 and W3738), Azoxystrobin application rate (0.006259, 0.06259 and 0.6259 g a.s./kg seed) and interactions between the factors. Formulation W3800 at its lowest application (0.006259 g a.s./kg seed) was used as the control.

### Deviations

The Heubach dust drift analysis should be conducted in rooms in which the temperature range is 20° C. to 25° C. In the present study the average temperature was 24.6° C., the highest recorded temperature was 28.5° C. The function of the Heubach was to expose the seeds to mechanical stress, the slight increase in temperature is unlikely to affect the Azoxystrobin retained by the seeds. All formulations and rates tested would be subjected to the same variation as all seeds were exposed to the same increase in temperature.

### Results

### Application and Equipment Calibration

Full details of the seed and formulation weights were recorded in laboratory book 19.

### Test System Monitoring/Assessment

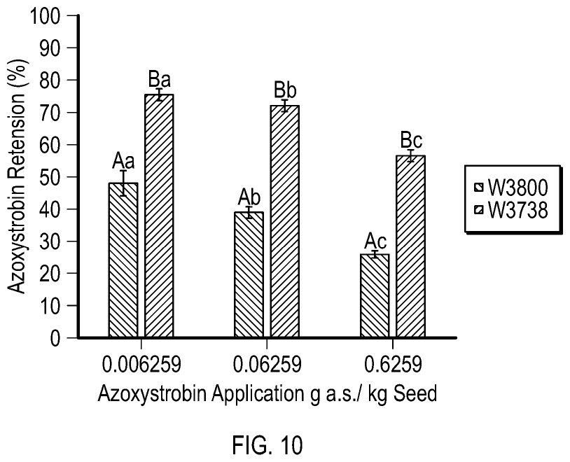

Across application rates formulation W3738 conferred 30% greater Azoxystrobin retention on maize seeds than formulation W3800 (F (1, 56)=284.5, p<0.001). Azoxystrobin retention decreased as the application rate increased (F (2, 56)=45.2, p<0.001). Compared to the lowest application rate (0.006259 g a.s./Kg) the medium (0.06259 g a.s./Kg) and high (0.6259 g a.s./Kg) applications retained 7% less and 21% less Azoxystrobin respectively. No significant interaction was observed between formulation type and application rate. A graph of the results is shown in FIG. 10.

FIG. 10 shows the percentage Azoxystrobin retention on maize seeds (mean±SE), at Low (0.006259 g a.s./Kg), medium (0.06259 g a.s./Kg) and high (0.006259 g a.s./Kg) with the Azoxystrobin application rates for formulations in both W3800 and W3738. Differences between capitalised letters denote significant differences between formulations. Differences between lower case letters denote significant differences between the application rates

### Environmental Monitoring

Average environmental conditions (Table 3) during the Heubach stress test were within the range stipulated in TDRF311-2. However, the temperature did deviate out of the upper temperature range. The Impact of which is discussed in section 12.

TABLE 3
Environmental conditions during the experimental period.

| | | Relative Humidity ± SD |
|---|---|---|
| Location | Temperature ± SD (° C.) | (%) |
| Incubator | 20 ± 0 | 68.5 ± 2.3 |
| Heubach | 24.6 ± 1.6 | 63.9 ± 1.3 |

### DISCUSSION

Carnauba based Entostat Azoxystrobin seed treatment (formulation W3738) retained 68% of the Azoxystrobin initially applied to the maize seed, this is 30% more Azoxystrobin than the 38% retained by the polyethylene based Entostat seed treatment (formulation W3800). Applications on maize seed were at greater than or equal to the commercial standard's label rate. After exposing the treated maize seeds to mechanical stress, the lowest Azoxystrobin application rate retained 62% of its original Azoxystrobin application. In comparison, the medium and high application rates retained 55% and 41% of their original Azoxystrobin application respectively. The higher the application rate, the more powdery the maize is, as more of the powder formulation is required to deliver the increased Azoxystrobin dose (Table 1). Although 21% of the Azoxystrobin was lost when the high application rate was tested, the dose of Azoxystrobin which remains on the surface of the maize (0.257 mg a.s./kg) is two orders of magnitude (100 times) greater than that of the low dose (0.00392 mg a.s./kg) and one order of magnitude (10 times) greater than the medium dose (0.0346 mg.s./kg). In reference to the main objective of this study, the optimum Entostat dry powder formulation to be tested for systemic activity, would be a carnauba based formulation applied at a medium or high application rate.

### Study 3

### Objective

The aim of the second objective of the Seed-Exo-5 project to be investigated is to demonstrate systemic activity of an Entostat™ dry powder seed treatment formulation containing the active ingredient (a.s.) Azoxystrobin. Azoxystrobin treated maize seeds were sewn and the resulting foliage harvested after 10 days. LC/MS-MS detected Azoxystrobin that had been transported systemically through the plant from seed to foliage.

### Introduction

This study aims to demonstrate systemic activity of a fungicide applied as a dry seed treatment. Translocation has been demonstrated using insecticide acetamiprid as a seed treatment. This study, namely Study 2, demonstrated that the percentage of Azoxystrobin retained on seed surfaces after mechanical stress significantly decreased as the amount of formulation applied increased. At the highest powder application rate tested (0.6259 g a.s./kg seed) polyethylene Entostat (W3800) retained 26% (0.162 g a.s. per kg) Azoxystrobin and carnauba Entostat (W3738) retained 56% (0.353 g a.s. per kg) Azoxystrobin. Polyethylene and carnauba Entostat retained quantities of Azoxystrobin which surpassed the recommended label rate of the commercial standard, making these two formulations at the high application rate suitable candidates for use in the present study. Treatments were applied to maize seeds. The Azoxystrobin treated maize seeds was sewn and the resulting foliage harvested after 10 days. Maize foliage was analysed by CEM Analytical Services Ltd. (CEMAS), UK. LC/MS-MS to detect Azoxystrobin that had been transported systemically through the plant from seed to foliage.

### Materials and Methods

Test Item Details
Test item type and 1. Polyethylene Entostat (W3800) containing 499 mg/g contents: Azoxystrobin fungicide.
   2. Carnauba Entostat (W3738) containing 435 mg/g Azoxystrobin fungicide.
Test item rate: 1. W3800 formulation was applied at 1.25 g/kg seeds equating to 0.6259 g a.s./kg seed.
   2. W3738 formulation was applied at 1.44 g/kg seeds equating to 0.6259 g a.s./kg seed.
Application interval: Single application at the start of the study
Supplier: Entostat, Exosect, UK
   Azoxystrobin, Albaugh, USA.
Storage: Pesticide freezer in particle size laboratory, Exosect

### Reference Item Details

Untreated maize seed was grown as untreated control (UTC) plant samples.

### Test System

Treatments were applied to untreated maize seeds (Table 1).

TABLE 1
Seed details

| Seed Type | Variety | Source | Batch Number | TGW (g) |
|---|---|---|---|---|
| Maize | MAS10C | Bright Seeds | B678 | 316 |

### Experimental Design

The independent factor in this study was dry powder seed treatment formulation type (W3800 and W3738). Detection of the active ingredient Azoxystrobin recovered from maize foliage after 10 days growth was quantified (Section 11.2). Each treatment was replicated ten times. The untreated control consisted of 2 replications.

### Pre-Experimental Procedures

Seeds were equilibrated in incubator 308 at 20° C.+2° C. and at 50%±10% relative humidity for at least 48 hours prior to formulation application.

### Experimental Procedures

### Treatment of Test System

For each treatment replicate the formulation was weighed into sterile 1 L Duran bottles along with 500 g of maize seeds. The maize and formulation homogenized for 30 seconds by gently agitating using the Stuart Rotator with MIX2040 attachment. 150 maize seeds were removed from each homogenised batch and planted across 3 seed trays (50 seeds per tray). Each seed tray contained 1.5 L of John Inns No 1. Once sewn the seed trays were placed in a capillary matting lined gravel tray and the complete set up randomly placed into a Dark Propagator 120 growth tent. One replicate (3 seed trays) from each test group (formulation) was randomly placed within each tent. A total of 10 tents was used equating to 10 samples per formulation. The capillary matting was watered as required for the duration of the study. The growth tents contained a single shelf with a Maxibright T5 120 cm fluorescent light suspended 108 cm above each shelf and set to a 16:8 hour light dark cycle. The front of the tents were left open to allow ventilation.

### Sampling/Measurement Regime

Seeds were grown for 10 days. After 10 days all plant foliage present above the soil surface were harvested and placed in a sealed plastic container. The container was stored below −18° C. prior to analysis in monitored freezers. Maize samples were homogenised in the presence of dry ice. QuEChERS extraction were used prior to detection of Azoxystrobin using LC/MS-MS.

Environmental Monitoring Data loggers were used to monitor temperature and relative humidity in the equilibration incubator 308. A monitoring system measured and record the temperature and relative humidity in the plant growth room.

### Statistical Analysis

Azoxystrobin was detected in the foliage of all plants grown from seeds treated with Entostat seed treatment formulations W3800 or W3738. No Azoxystrobin was recovered from the untreated control plant foliage, thus yielding no Azoxystrobin values for analysis. The control results were not included in the statistical analysis. The recovered Azoxystrobin values from plants treated with either W3800 or W3738 were analysed using a Welsh two sample t-test.

### Deviations

Azoxystrobin was clearly observed in the treated plants and absence from the untreated control plants. The statistical analysis selected in the study plan was changed to compare the amount of Azoxystrobin that had moved systemically through the plants for each formulation.

### Results

### Test System Monitoring/Assessment

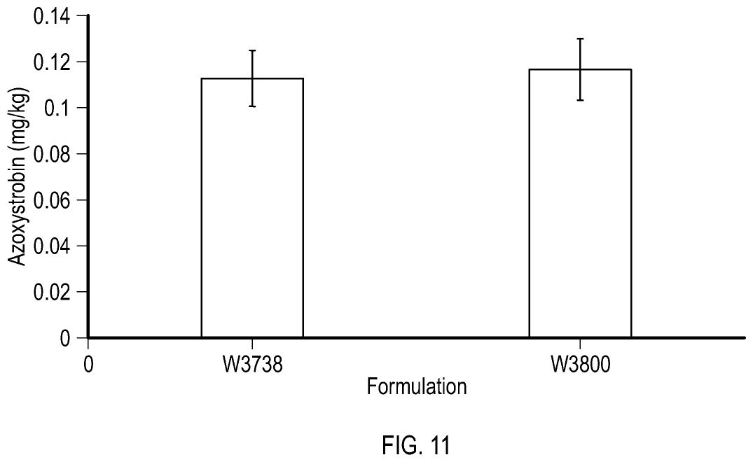

Azoxystrobin detected in 10 day old plant foliage was the same for each formulation (t=−0.24, d.f.=17.77, p=0.81), as shown in FIG. 11.

### Discussion

Azoxystrobin formulated using Entostat and applied as a seed treatment to the surface of maize has demonstrated systemic activity. Irrespective of the seed treatment formulation (W3800 or W3738) used to inoculate the maize seeds, 20% (was 0.114 mg/kg) of the 0.6259 g/kg Azoxystrobin initially applied moved systemically through the plant to be present in the 10 day old maize foliage.

### REFERENCES

Bartlett, D. W., Clough, J. M., Godfrey, C. R. A., Godwin, J. R., Hall, A. A., Heaney, S. P., and S. J. Maund (2001). Understanding the Strobilurin fungicides. Pesticide Outlook 12, 143-148.
Bertelsen, J. R., de Neergaard, E., and V. Smedegaard-Petersen (2001). Fungicidal effects of azoxystrobin and epoxiconazole on phyllosphere fungi, senescence and yield of winter wheat. Plant Pathology 50, 190-205
Campos E. V. R., de Oliveira, J. L. and L. F. Fraceto (2014) Applications of controlled release systems for fungicides, herbicides, acaricides, nutrients, and plant growth hormones: a review. Advanced Science Engineering and Medicine 6, 373-387.
EPPO PP 1/135 (4) Phytotoxicity assessment, Efficacy evaluation of plant protection products. Bulletin OEPP/EPPO Bulletin (2014) 44 (3), 265-273
Fernández-ortuio, D., Torés, J. A., De Vicente, A., and A. Pérez-garcia (2010). The QoI Fungicides, the Rise and Fall of a Successful Class of Agricultural Fungicides. Fungicides. Odile Carisse (Ed.). ([Online] http://www.intechopen.com/books/fungicides/the-qoifungicides-the-rise-and-fall-of-a-successful-class-of-agricultural-fungicides (Accessed: 29 Jul. 2016)).
Field, R. J. and N. G. Bishop 1988. Promotion of stomatal infiltration of glyphosate by an organosilicone surfactant reduces the critical rainfall period. Pesticide Science 24, 55-62.
FRAC. (2016). Mode of action of fungicides. ([Online] http://www.frac.info/(Accessed: 29 Jul. 2016)).
Gogos A, Knauer K. and T. D. Bucheli (2012) Nanomaterials in plant protection and fertilization: current state, foreseen applications, and research priorities. J Agric Food Chem 60, 9781-9792.
HRAC. (2016). Mode of action of fungicides. ([Online] http://hracglobal.com/tools/(Accessed: 20 Dec. 2016)).
Lee, P. I. and W. R. Good (1987) Overview of controlled-release drug delivery. American Chemical Society Symposium Series 348, 1-13
Masuda, M. (2011) Microencapsulation of Pesticides for Controlling Release from Coatings. PhD Thesis. Department of Chemical and Biological Engineering Chalmers University of Technology Göteborg, Sweden
Nair, R., Varghese, S. H., Nair, G. B., Maekawa, T., Yoshida, Y., and D. S. Kumar (2010) Nanoparticulate material delivery to plants. Plant Science 179, 154-163
Olson, F. C. W. (1950) Quantitative estimates of filamentous algae. Transactions of the American Microscopy Society 69, 272-279.
Roy, A., Bajpai, J. and A. K. Bajpai (2009) Dynamics of controlled release of chlorpyrifos from swelling and eroding biopolymeric microspheres of calcium alginate and starch. Carbohydr Polym 76, 222-231.
Schonherr, J. and P. Baur (1996) Effects of temperature, surfactants and other adjuvants on rates of uptake of organic compounds. In: Kerstiens, G. (Ed.), Plant Cuticles—An Integrated Functional Approach. Bios Scientific Publishers, Oxford, UK, pp. 134-154.
Solel Z. and L. V. Edgington (1973) Transcuticular Movement of Fungicides. Phytopathology 63, 505-510.
Sopeña, F., Maqueda, C. and E. Morillo (2007) Norflurazon mobility, dissipation, activity, and persistence in a sandy soil as influenced by formulation. J Agric Food Chem 55, 3561-3567.
Sudisha, J., Amruthesh, K. N., Deepak, S. A., Shetty, N. P., Sarosh, B. R., and H. Shekar Shetty (2005). Comparative efficacy of strobilurin fungicides against downy mildew disease of pearl millet. Pesticide Biochemistry and Physiology 81, 188-197.
Wang, C. J. and Z. Q. Liu (2007) Foliar uptake of pesticides—present status and future challenges. Pesticide Biochemistry and Physiology 87, 1-8
Wege, P. J., Hoppé, M. A., Bywater, A. F., Weeks, S. D. and T. S. Gallo (1999) A microencapsulated formulation of lambda-cyhalothrin In Robinson, W. H. Rettich, F. and G. W. Rambo (eds) Proceedings of the 3^{rd} International Conference on Urban pests, pp 301-310 Hronow, Czech Republic

1. A method of delivering a non-arthropod systemically-acting pesticide to a plant, comprising applying to one or more aerial parts of the plant a liquid formulation comprising particles according to claim 10.

2. A method according to claim 1 for killing the plant, wherein the pesticide is a herbicide.

3. A method according to claim 1 for treating or preventing fungal infection of the plant, wherein the pesticide is a fungicide.

4. A method according to claim 1, wherein the particles have a mass median diameter (MMD) of up to 300 μm, optionally wherein the particles have a mass median diameter (MMD) of 1 μm to 200 μm.

5. (canceled)

6. A method according to claim 1, wherein the particles are selected from particles comprising natural waxes, synthetic waxes, and mineral waxes and mixtures thereof having a melting point of ≥40° C., and preferably of ≥50° C.; and/or wherein the particles are solid wax particles made substantially throughout of wax or mixtures of waxes.

7. A method according to claim 6, wherein the wax is selected from paraffin wax, beeswax, carnauba wax, lanolin, shellac wax, bayberry wax, sugar cane wax, ozocerite, ceresin wax, montan wax, candelilla wax, castor wax, microcrystalline wax, ouricury wax, polyethylene wax and rice bran wax, and mixtures of two or more thereof, wherein the wax is optionally selected from polyethylene wax and carnauba wax and a mixture thereof.

8. (canceled)

9. (canceled)

10. A liquid formulation for applying to aerial parts of plants comprising:
i) a non-arthropod systemically-acting pesticide; and
ii) carrier particles including at least an outer surface comprising an organic matter constituent,
wherein the systemically-acting pesticide is combined within and/or on the surface of the carrier particles, the carrier particles being in particulate form and capable of carrying an electrostatic surface charge.

11. A formulation according to claim 10, wherein the aerial parts of plants are selected from leaves, stems, petioles, and flower parts.

12. A formulation according to claim 10 wherein the carrier particles are selected from particles comprising natural waxes, synthetic waxes, and mineral waxes and mixtures thereof having a melting point of ≥40° C., and preferably of ≥50° C.

13. A formulation according to claim 12, wherein the wax is selected from paraffin wax, beeswax, carnauba wax, lanolin, shellac wax, bayberry wax, sugar cane wax, ozocerite, ceresin wax, montan wax, candelilla wax, castor wax, microcrystalline wax, ouricury wax, polyethylene wax and rice bran wax, and mixtures of two or more thereof; wherein the wax is optionally selected from polyethylene wax and carnauba wax and a mixture thereof.

14. (canceled)

15. A formulation according to claim 10, wherein the non-arthropod pesticide is selected from a systemically-acting fungicide and a herbicide.

16. A formulation according to claim 10, wherein the non-arthropod pesticide is a systemically-acting fungicide selected from systemic benzimidazoles, systemic imidazoles, systemic Carboxin and related compounds (Oxathiins), systemic carbamates, systemic phenylamides, systemic phosphonates, systemic pyrimidines, systemic pyridines, systemic piperazines, systemic triazoles, systemic morpholines, systemic strobilurins, systemic phosphorothiolates, systemic cyanoacetamide oximes, systemic aryl sulfonylallyl trichloromethyl sulfoxides and mixtures of two or more thereof.

17. A formulation according to claim 10, wherein the non-arthropod pesticide is a systemic strobilurin selected from Azoxystrobin, Dimoxystrobin, Enestrobin (also known as Enestroburin), Fluoxastrobin, Pyraclostrobin, Picoxystrobin, Kresoxim-methyl, Metominostrobin, and Trifloxystrobin and mixtures of two or more thereof.

18. A formulation according to claim 10, wherein the non-arthropod pesticide is a systemically-acting herbicide selected from systemic plant growth regulators such as phenoxy compounds, pyridines, systemically-acting auxin transport inhibitors such as phthalamates, and semicarbazones, systemically-acting amino acid biosynthesis inhibitors such as imidazolinones, sulfonylureas, sulfonylamino-carboynyl-triazolinones, sulphonamides, systemically-acting glycine derivatives such as glyphosates, systemically-acting fatty acid biosynthesis inhibitors such as aryloxyphenoxy propionates, cycohexadiones, and phenylpyrazolines, systemically-acting seedling growth inhibitors such as dinitroanilines, pyridines, benzamides, benzoic acids, carbamates, and nitriles, systemically-acting seedling growth inhibitors such as the chloroacetamides, oxyacetamides, thiocarbamates, phosphorodithioates, and acetamides, systemically-acting photosynthesis inhibitors (mobile I) such as triazines, triazinones, and uracils, systemically-acting photosynthesis inhibitors (mobile II) such as ureas, systemically-acting photosynthesis inhibitors (non-mobile; ‘rapid acting’) such as nitriles, benzothiadazoles, phenyl-pyridazines, systemically-acting cell membrane disruptors such as diphenyl ethers, N-phenyl-phthalimides, ozadiazoles, triazolinones, and bipyridyliums, systemically acting pigment inhibitors such as isoxazolidinones pyridazinones, isoxazoles, triketones and systemically-acting phosphorylated amino acids (N-metabolism disruptors) including amino acid derivatives such as phosphinic acids and mixtures of two or more thereof.

19. A formulation according to claim 10, wherein the non-arthropod pesticide is a systemically-acting herbicide selected from a pyridine, a sulfonyl urea, a glyphosate, a sulfonylamino-carboynyl-triazolinone, an aryloxyphenoxy propionate, a cyclohexanedione, a carbamate, a dinitroaniline, a chloroacetamide, a triazine, a triazinone, a urea, a nitrile, a benzothiadazole, a diphenyl ether, an isoxazole, a triketone and mixtures of two or more thereof.

20. A formulation according to claim 10, wherein the systemically-acting pesticide is present at up to 50% w/w of the carrier particles; and/or wherein the formulation is selected from an aqueous formulation and an oleaginous formulation.

21. (canceled)

22. A composite particle comprising:
i) a non-arthropod systemically-acting pesticide; and
ii) a carrier particle including at least an outer surface comprising an organic matter constituent,
wherein the said systemically-acting pesticide is selected from at least one herbicide or at least one chemical fungicide, the pesticide being combined within and/or on the surface of the composite particle, the composite particle being capable of carrying an electrostatic surface charge.

23. A particle according to claim 22, wherein the non-arthropod systemically-acting pesticide is an herbicide selected from:
a pyridine, a sulfonyl urea, a glyphosate, a sulfonylamino-carboynyl-triazolinone, an aryloxyphenoxy propionate, a cyclohexanedione, a carbamate, a dinitroaniline, a chloroacetamide, a triazine, a triazinone, a urea, a nitrile, a benzothiadazole, a diphenyl ether, an isoxazole, a triketone and mixtures of two or more thereof; or
a systemically-acting herbicide selected from systemic plant growth regulators such as phenoxy compounds, pyridines, systemically-acting auxin transport inhibitors such as phthalamates, and semicarbazones, systemically-acting amino acid biosynthesis inhibitors such as imidazolinones, sulfonylureas, sulfonylamino-carboynyl-triazolinones, sulphonamides, systemically-acting glycine derivatives such as glyphosates, systemically-acting fatty acid biosynthesis inhibitors such as aryloxyphenoxy propionates, cycohexadiones, and phenylpyrazolines, systemically-acting seedling growth inhibitors such as dinitroanilines, pyridines, benzamides, benzoic acids, carbamates, and nitriles, systemically-acting seedling growth inhibitors such as the chloroacetamides, oxyacetamides, thiocarbamates, phosphorodithioates, and acetamides, systemically-acting photosynthesis inhibitors (mobile I) such as triazines, triazinones, and uracils, systemically-acting photosynthesis inhibitors (mobile II) such as ureas, systemically-acting photosynthesis inhibitors (non-mobile; ‘rapid acting’) such as nitriles, benzothiadazoles, phenyl-pyridazines, systemically-acting cell membrane disruptors such as diphenyl ethers, N-phenyl-phthalimides, ozadiazoles, triazolinones, and bipyridyliums, systemically acting pigment inhibitors such as isoxazolidinones pyridazinones, isoxazoles, triketones and systemically-acting phosphorylated amino acids (N-metabolism disruptors) including amino acid derivatives such as phosphinic acids and mixtures of two or more thereof
or is a fungicide selected from:
systemic benzimidazoles, systemic imidazoles, systemic Carboxin and related compounds (Oxathiins), systemic carbamates, systemic phenylamides, systemic phosphonates, systemic pyrimidines, systemic pyridines, systemic piperazines, systemic triazoles, systemic morpholines, systemic strobilurins, systemic phosphorothiolates, systemic cyanoacetamide oximes, systemic aryl sulfonylallyl trichloromethyl sulfoxides and mixtures of two or more thereof.

24. A particle according to claim 22, wherein the organic matter constituent comprises a wax selected from natural waxes, synthetic waxes, mineral waxes and mixtures of two or more thereof, wherein the organic matter constituent is optionally selected from a polyethylene wax and carnauba wax.

25. (canceled)

26. A population of particles as defined in claim 22, wherein the particles have a median diameter of up to 300 μm, optionally from 1 μm to 200 μm, optionally from 1 μm to 100 μm.

27. (canceled)

28. (canceled)

29. (canceled)
